(19) United States
(12) Patent Application Publication
(10) Pub. No.: US 2024/0015601 A1
(43) Pub. Date: Jan. 11, 2024

(54) CELL MANAGEMENT FOR INTER-CELL MOBILITY

(71) Applicant: QUALCOMM Incorporated, San Diego, CA (US)

(72) Inventors: Shanyu Zhou, San Diego, CA (US); Jelena Damnjanovic, Del Mar, CA (US); Tao Luo, San Diego, CA (US)

(21) Appl. No.: 17/857,735

(22) Filed: Jul. 5, 2022

(51) Int. Cl. H04W 36/00; H04W 24/02

(52) U.S. Cl. CPC H04W 36/0016; H04W 24/02

(57) ABSTRACT

Methods, systems, and devices for wireless communications are described. A network entity may configure a set of cells for communications with a user equipment (UE). The set of cells may include a first cell configured as a special cell (SpCell) and a second cell configured as a secondary cell (SCell). The network entity may indicate an SpCell configuration and an SCell configuration for communications with the first cell and an SCell configuration and a SpCell configuration for communications with the second cell. As such, if the network entity reconfigures the first cell as an SCell and reconfigures the second cell as a SpCell, the UE may communicate with the first cell using the SCell configuration, and the UE may communicate with the second cell using the SpCell configuration. The described techniques also include cell index management to support dynamic reconfiguration of a cell as a SpCell or an SCell.

### FIELD OF TECHNOLOGY

The following relates to wireless communications, including cell management for inter-cell mobility.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). In some wireless communications systems, a network entity may configure a set of cells for communications with a UE. Improved techniques for supporting communications between a UE and one or more cells in a configured set of cells may be desirable.

### SUMMARY

The described techniques relate to improved methods, systems, devices, and apparatuses that support cell management for inter-cell mobility. For example, the described techniques support dynamic reconfiguration of a cell as a special cell (SpCell) or a secondary cell (SCell). A network entity may configure a set of cells for communications with a UE. The set of cells may include a first cell configured as a SpCell and a second cell configured as an SCell. The network entity may indicate an SpCell configuration and an SCell configuration for communications with the first cell and an SCell configuration and an SpCell configuration for communications with the second cell. As such, if the network entity reconfigures the first cell as an SCell and reconfigures the second cell as an SpCell, the UE may communicate with the first cell using the SCell configuration, and the UE may communicate with the second cell using the SpCell configuration. The described techniques also include cell index management to support dynamic reconfiguration of a cell as an SpCell or an SCell.

A method for wireless communication at a user equipment (UE) is described. The method may include receiving an indication of a configuration of a set of cells, the configuration including a secondary cell configuration for a first cell of the set of cells that is configured as a special cell at a first time and a special cell configuration for a second cell of the set of cells that is configured as a secondary cell at the first time, receiving a control message configuring the first cell as a secondary cell at a second time and configuring the second cell as a special cell at the second time, and communicating, after the second time, with the first cell in accordance with the secondary cell configuration for the first cell and with the second cell in accordance with the special cell configuration for the second cell.

An apparatus for wireless communication at a UE is described. The apparatus may include a processor, memory coupled with the processor, and instructions stored in the memory. The instructions may be executable by the processor to cause the apparatus to receive an indication of a configuration of a set of cells, the configuration including a secondary cell configuration for a first cell of the set of cells that is configured as a special cell at a first time and a special cell configuration for a second cell of the set of cells that is configured as a secondary cell at the first time, receive a control message configuring the first cell as a secondary cell at a second time and configuring the second cell as a special cell at the second time, and communicate, after the second time, with the first cell in accordance with the secondary cell configuration for the first cell and with the second cell in accordance with the special cell configuration for the second cell.

Another apparatus for wireless communication at a UE is described. The apparatus may include means for receiving an indication of a configuration of a set of cells, the configuration including a secondary cell configuration for a first cell of the set of cells that is configured as a special cell at a first time and a special cell configuration for a second cell of the set of cells that is configured as a secondary cell at the first time, means for receiving a control message configuring the first cell as a secondary cell at a second time and configuring the second cell as a special cell at the second time, and means for communicating, after the second time, with the first cell in accordance with the secondary cell configuration for the first cell and with the second cell in accordance with the special cell configuration for the second cell.

A non-transitory computer-readable medium storing code for wireless communication at a UE is described. The code may include instructions executable by a processor to receive an indication of a configuration of a set of cells, the configuration including a secondary cell configuration for a first cell of the set of cells that is configured as a special cell at a first time and a special cell configuration for a second cell of the set of cells that is configured as a secondary cell at the first time, receive a control message configuring the first cell as a secondary cell at a second time and configuring the second cell as a special cell at the second time, and communicate, after the second time, with the first cell in accordance with the secondary cell configuration for the first cell and with the second cell in accordance with the special cell configuration for the second cell.

Some examples of the method, apparatuses, and non-transitory computer-readable medium described herein may further include operations, features, means, or instructions for receiving an indication of a first special cell configuration for the first cell and a first secondary cell configuration for the second cell and communicating, after the first time, with the first cell in accordance with the first special cell configuration for the first cell and with the second cell in accordance with the first secondary cell configuration for the second cell.

Some examples of the method, apparatuses, and non-transitory computer-readable medium described herein may further include operations, features, means, or instructions for receiving an indication of a second special cell configuration for the first cell and a second secondary cell configuration for the second cell and communicating, after a third time, with the first cell in accordance with the second special cell configuration for the first cell and with the second cell in accordance with the second secondary cell configuration for the second cell.

Some examples of the method, apparatuses, and non-transitory computer-readable medium described herein may further include operations, features, means, or instructions for receiving an indication of a second special cell configuration for the first cell and a second secondary cell configuration for the second cell and communicating, after a third time, with the first cell in accordance with the first special cell configuration for the first cell and with the second cell in accordance with the first secondary cell configuration for the second cell.

Some examples of the method, apparatuses, and non-transitory computer-readable medium described herein may further include operations, features, means, or instructions for receiving an indication of a second special cell configuration for the first cell and a second secondary cell configuration for the second cell, receiving, in a second control message, an indication of whether to communicate, after a third time, with the first cell in accordance with the first special cell configuration for the first cell or the second special cell configuration for the first cell, receiving, in the second control message, an indication of whether to communicate, after the third time, with the second cell in accordance with the first secondary cell configuration for the second cell or the second secondary cell configuration for the second cell, and communicating, after the third time, with the first cell and the second cell in accordance with the second control message.

In some examples of the method, apparatuses, and non-transitory computer-readable medium described herein, receiving the indication of the secondary cell configuration for the first cell and the special cell configuration for the second cell may include operations, features, means, or instructions for receiving an indication of a set of multiple secondary cell configurations for the first cell and a set of multiple special cell configurations for the second cell, where the control message indicates the secondary cell configuration for the first cell from the set of multiple secondary cell configurations and the special cell configuration for the second cell from the set of multiple special cell configurations.

In some examples of the method, apparatuses, and non-transitory computer-readable medium described herein, the secondary cell configuration for the first cell and the special cell configuration for the second cell may be received in a mobility configuration.

Some examples of the method, apparatuses, and non-transitory computer-readable medium described herein may further include operations, features, means, or instructions for receiving an indication of a measurement configuration for performing measurements on reference signals received from each deactivated cell of the set of cells.

Some examples of the method, apparatuses, and non-transitory computer-readable medium described herein may further include operations, features, means, or instructions for receiving an indication of a secondary cell index for the first cell, where the secondary cell index for the first cell may be different from secondary cell indices for other cells in the set of cells configured for communications with the UE.

Some examples of the method, apparatuses, and non-transitory computer-readable medium described herein may further include operations, features, means, or instructions for receiving an indication of a range of secondary cell indices for the first cell, where the control message includes an indication of a secondary cell index for the first cell at the second time, the secondary cell index selected from the range of secondary cell indices for the first cell.

In some examples of the method, apparatuses, and non-transitory computer-readable medium described herein, a special cell index for the second cell may be zero at the second time, and a secondary cell index for the second cell may be invalid at the second time.

Some examples of the method, apparatuses, and non-transitory computer-readable medium described herein may further include operations, features, means, or instructions for receiving a second control message configuring the second cell as a secondary cell at a third time, where a secondary cell index of the second cell at the third time includes a secondary cell index of the second cell at the first time.

Some examples of the method, apparatuses, and non-transitory computer-readable medium described herein may further include operations, features, means, or instructions for receiving an indication of a secondary cell index for the second cell and receiving a second control message configuring the second cell as a secondary cell at a third time, where a secondary cell index of the second cell at the third time includes the indicated secondary cell index.

In some examples of the method, apparatuses, and non-transitory computer-readable medium described herein, the control message includes a layer one or layer two control message.

A method for wireless communication at a network entity is described. The method may include transmitting, to a UE, an indication of a configuration of a set of cells, the configuration including a secondary cell configuration for a first cell of the set of cells that is configured as a special cell at a first time and a special cell configuration for a second cell of the set of cells that is configured as a secondary cell at the first time, transmitting, to the UE, a control message configuring the first cell as a secondary cell at a second time and configuring the second cell as a special cell at the second time, and communicating, after the second time, with the UE via the first cell in accordance with the secondary cell configuration for the first cell and with the UE via the second cell in accordance with the special cell configuration for the second cell.

An apparatus for wireless communication at a network entity is described. The apparatus may include a processor, memory coupled with the processor, and instructions stored in the memory. The instructions may be executable by the processor to cause the apparatus to transmit, to a UE, an indication of a configuration of a set of cells, the configuration including a secondary cell configuration for a first cell of the set of cells that is configured as a special cell at a first time and a special cell configuration for a second cell of the set of cells that is configured as a secondary cell at the first time, transmit, to the UE, a control message configuring the first cell as a secondary cell at a second time and configuring the second cell as a special cell at the second time, and communicate, after the second time, with the UE via the first cell in accordance with the secondary cell configuration for the first cell and with the UE via the second cell in accordance with the special cell configuration for the second cell.

Another apparatus for wireless communication at a network entity is described. The apparatus may include means for transmitting, to a UE, an indication of a configuration of a set of cells, the configuration including a secondary cell configuration for a first cell of the set of cells that is configured as a special cell at a first time and a special cell configuration for a second cell of the set of cells that is configured as a secondary cell at the first time, means for transmitting, to the UE, a control message configuring the first cell as a secondary cell at a second time and configuring the second cell as a special cell at the second time, and means for communicating, after the second time, with the UE via the first cell in accordance with the secondary cell configuration for the first cell and with the UE via the second cell in accordance with the special cell configuration for the second cell.

A non-transitory computer-readable medium storing code for wireless communication at a network entity is described. The code may include instructions executable by a processor to transmit, to a UE, an indication of a configuration of a set of cells, the configuration including a secondary cell configuration for a first cell of the set of cells that is configured as a special cell at a first time and a special cell configuration for a second cell of the set of cells that is configured as a secondary cell at the first time, transmit, to the UE, a control message configuring the first cell as a secondary cell at a second time and configuring the second cell as a special cell at the second time, and communicate, after the second time, with the UE via the first cell in accordance with the secondary cell configuration for the first cell and with the UE via the second cell in accordance with the special cell configuration for the second cell.

Some examples of the method, apparatuses, and non-transitory computer-readable medium described herein may further include operations, features, means, or instructions for transmitting an indication of a first special cell configuration for the first cell and a first secondary cell configuration for the second cell and communicating, after the first time, with the UE via the first cell in accordance with the first special cell configuration for the first cell and with the UE via the second cell in accordance with the first secondary cell configuration for the second cell.

Some examples of the method, apparatuses, and non-transitory computer-readable medium described herein may further include operations, features, means, or instructions for transmitting an indication of a second special cell configuration for the first cell and a second secondary cell configuration for the second cell and communicating, after a third time, with the UE via the first cell in accordance with the second special cell configuration for the first cell and with the UE via the second cell in accordance with the second secondary cell configuration for the second cell.

Some examples of the method, apparatuses, and non-transitory computer-readable medium described herein may further include operations, features, means, or instructions for transmitting an indication of a second special cell configuration for the first cell and a second secondary cell configuration for the second cell and communicating, after a third time, with the UE via the first cell in accordance with the first special cell configuration for the first cell and with the UE via the second cell in accordance with the first secondary cell configuration for the second cell.

Some examples of the method, apparatuses, and non-transitory computer-readable medium described herein may further include operations, features, means, or instructions for transmitting an indication of a second special cell configuration for the first cell and a second secondary cell configuration for the second cell, transmitting, in a second control message, an indication of whether the UE may be to communicate, after a third time, with the first cell in accordance with the first special cell configuration for the first cell or the second special cell configuration for the first cell, transmitting, in the second control message, an indication of whether the UE may be to communicate, after the third time, with the second cell in accordance with the first secondary cell configuration for the second cell or the second secondary cell configuration for the second cell, and communicating, after the third time, with the UE via the first cell and the second cell in accordance with the second control message.

In some examples of the method, apparatuses, and non-transitory computer-readable medium described herein, transmitting the indication of the secondary cell configuration for the first cell and the special cell configuration for the second cell may include operations, features, means, or instructions for transmitting an indication of a set of multiple secondary cell configurations for the first cell and a set of multiple special cell configurations for the second cell, where the control message indicates the secondary cell configuration for the first cell from the set of multiple secondary cell configurations and the special cell configuration for the second cell from the set of multiple special cell configurations.

In some examples of the method, apparatuses, and non-transitory computer-readable medium described herein, the secondary cell configuration for the first cell and the special cell configuration for the second cell may be transmitted in a mobility configuration.

Some examples of the method, apparatuses, and non-transitory computer-readable medium described herein may further include operations, features, means, or instructions for transmitting an indication of a measurement configuration for the UE to perform measurements on reference signals received from each deactivated cell of the set of cells.

Some examples of the method, apparatuses, and non-transitory computer-readable medium described herein may further include operations, features, means, or instructions for transmitting an indication of a secondary cell index for the first cell, where the secondary cell index for the first cell may be different from secondary cell indices for other cells in the set of cells configured for communications with the UE.

Some examples of the method, apparatuses, and non-transitory computer-readable medium described herein may further include operations, features, means, or instructions for transmitting an indication of a range of secondary cell indices for the first cell, where the control message includes an indication of a secondary cell index for the first cell at the second time, the secondary cell index selected from the range of secondary cell indices for the first cell.

In some examples of the method, apparatuses, and non-transitory computer-readable medium described herein, a special cell index for the second cell may be zero at the second time, and a secondary cell index for the second cell may be invalid at the second time.

Some examples of the method, apparatuses, and non-transitory computer-readable medium described herein may further include operations, features, means, or instructions for transmitting a second control message configuring the second cell as a secondary cell at a third time, where a secondary cell index of the second cell at the third time includes a secondary cell index of the second cell at the first time.

Some examples of the method, apparatuses, and non-transitory computer-readable medium described herein may further include operations, features, means, or instructions for transmitting an indication of a secondary cell index for the second cell and transmitting a second control message configuring the second cell as a secondary cell at a third time, where a secondary cell index of the second cell at the third time includes the indicated secondary cell index.

In some examples of the method, apparatuses, and non-transitory computer-readable medium described herein, the control message includes a layer one or layer two control message.

### BRIEF DESCRIPTION OF THE DRAWINGS

FIG. 1 illustrates an example of a wireless communications system that supports cell management for inter-cell mobility in accordance with one or more aspects of the present disclosure.

FIG. 2 illustrates an example of inter-cell mobility in accordance with one or more aspects of the present disclosure.

FIG. 3 illustrates an example of a wireless communications system that supports cell management for inter-cell mobility in accordance with one or more aspects of the present disclosure.

FIG. 4 illustrates an example of cell index management in accordance with one or more aspects of the present disclosure.

FIG. 5 illustrates an example of a process flow that supports cell management for inter-cell mobility in accordance with one or more aspects of the present disclosure.

FIGS. 6 and 7 show block diagrams of devices that support cell management for inter-cell mobility in accordance with one or more aspects of the present disclosure.

FIG. 8 shows a block diagram of a communications manager that supports cell management for inter-cell mobility in accordance with one or more aspects of the present disclosure.

FIG. 9 shows a diagram of a system including a device that supports cell management for inter-cell mobility in accordance with one or more aspects of the present disclosure.

FIGS. 10 and 11 show block diagrams of devices that support cell management for inter-cell mobility in accordance with one or more aspects of the present disclosure.

FIG. 12 shows a block diagram of a communications manager that supports cell management for inter-cell mobility in accordance with one or more aspects of the present disclosure.

FIG. 13 shows a diagram of a system including a device that supports cell management for inter-cell mobility in accordance with one or more aspects of the present disclosure.

FIGS. 14 and 15 show flowcharts illustrating methods that support cell management for inter-cell mobility in accordance with one or more aspects of the present disclosure.

### DETAILED DESCRIPTION

In some wireless communications systems, a network entity may configure a set of cells for communications with a user equipment (UE). The configured set of cells may include activated cells and deactivated cells. A UE may communicate with the activated cells in the configured set of cells, and the deactivated cells may be subsequently activated for communications with the UE. A network entity may use dynamic signaling (e.g., layer one (L1) or layer two (L2) signaling) to activate and deactivate cells in the configured set of cells to allow a UE to communicate with different subsets of the configured set of cells. A network entity may also use dynamic signaling to reconfigure a special cell (SpCell) in the configured set of cells as a secondary cell (SCell) and reconfigure an SCell in the configured set of cells as an SpCell. In some cases, however, techniques for supporting dynamic reconfiguration of a cell as an SpCell or an SCell may be deficient. Further, techniques for assigning an index to a cell after dynamic reconfiguration of the cell as an SpCell or an SCell may be undefined.

As described herein, a wireless communications system may support efficient techniques to facilitate dynamic reconfiguration of a cell as an SpCell or an SCell. A network entity may configure a set of cells for communications with a UE. The set of cells may include a first cell configured as an SpCell and a second cell configured as an SCell. Thus, the network entity may indicate an SpCell configuration for communications with the first cell and an SCell configuration for communications with the second cell. In addition, the network entity may indicate an SCell configuration for communications with the first cell and an SpCell configuration for communications with the second cell. As such, if the network entity reconfigures the first cell as an SCell and reconfigures the second cell as an SpCell, the UE may communicate with the first cell in accordance with the SCell configuration, and the UE may communicate with the second cell in accordance with the SpCell configuration.

A UE may also identify an SCell index for a first cell and an SpCell index for a second cell even if the first cell is initially configured as an SpCell and the second cell is initially configured as an SCell. As such, if a network entity reconfigures the first cell as an SCell and reconfigures the second cell as an SpCell, the UE may determine the SCell index for the first cell and the SpCell index for the second cell. In some cases, the UE may receive an indication of the SCell index for the first cell, and the SCell index for the first cell may be different from SCell indices for other cells in the configured set of cells. In some cases, the UE may determine that the SpCell index for the second cell is zero, and the SCell index for the second cell may be invalid once the second cell is reconfigured as an SpCell. In such cases, if the second cell is reconfigured again as an SCell, the UE may reapply (e.g., validate) the invalidated SCell index for the second cell.

Aspects of the disclosure are initially described in the context of wireless communications systems. Aspects of the disclosure are further illustrated by and described with reference to apparatus diagrams, system diagrams, and flowcharts that relate to cell management for inter-cell mobility.

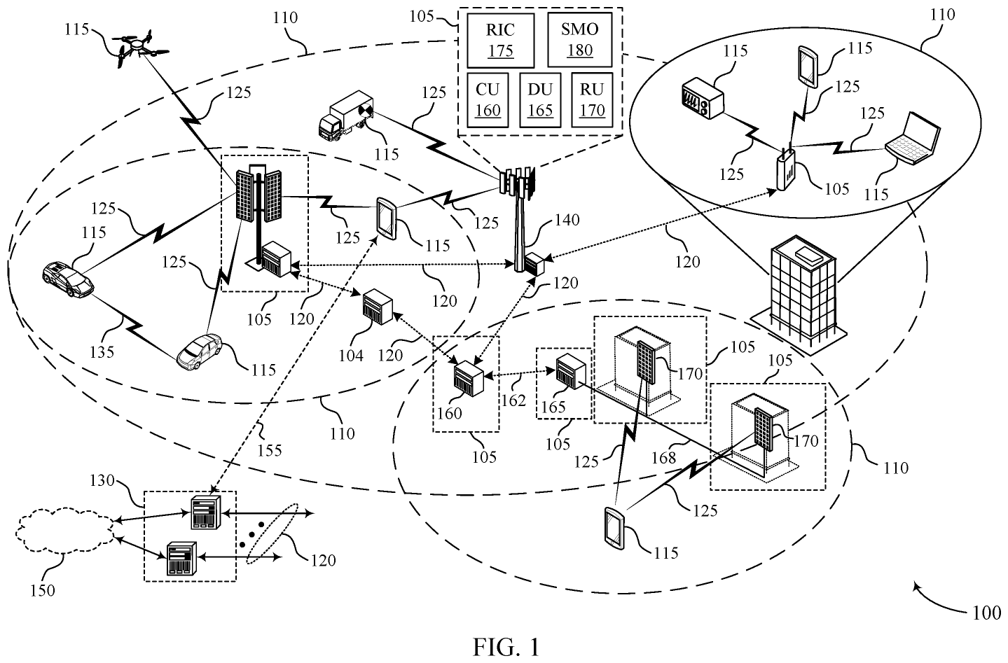

FIG. 1 illustrates an example of a wireless communications system 100 that supports cell management for inter-cell mobility in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support cell management for inter-cell mobility as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells (e.g., with one or more UEs 115) using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices. A UE 115 may be configured with a primary cell (PCell) and one or more SCells with which to communicate. For instance, the UE 115 may communicate with the PCell and the one or more SCells if the UE 115 is configured for dual connectivity (DC) or carrier aggregation (CA). The UE 115 may use the PCell for initial access to a network (e.g., initial access to a master cell group (MCG)) and other communications, and the UE 115 may use the one or more SCells for supplementary communications. In some cases, the UE 115 may be configured with a primary secondary cell (PSCell) that the UE 115 may use for initial access to one or more SCells (e.g., initial access to a secondary cell group (SCG)). A PCell or a PSCell may be referred to as a special cell (SpCell), or an SpCell may refer to a PCell or a PSCell (Primary Cell of an SCG). An SpCell configuration for an MCG may correspond to a PCell configuration, and an SpCell configuration for an SCG may correspond to a PSCell configuration.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In wireless communications system 100, a network entity 105 may configure a set of cells for communications with a UE 115. The network entity 105 may be connected to or support communications via at least one cell of the set of cells, and the network entity 105 may configure the UE 115 with the set of cells via the at least one cell. The configured set of cells may include activated cells and deactivated cells. A UE 115 may communicate with the activated cells in the configured set of cells, and the deactivated cells may be activated for communications with the UE 115 (e.g., when appropriate). A network entity 105 may use dynamic signaling (e.g., L1 or L2 signaling, such as downlink control information (DCI) messages or MAC control elements (MAC-CEs)) to activate and deactivate cells in the configured set of cells to maximize throughput (e.g., by allowing a UE 115 to communicate with an optimal subset of the configured set of cells). A network entity 105 may also use dynamic signaling to reconfigure an SpCell in the configured set of cells as an SCell and reconfigure an SCell in the configured set of cells as an SpCell. The use of dynamic signaling to activate and deactivate cells in a configured set of cells and reconfigure cells as SpCells or SCells may be referred to as L1/L2-based inter-cell mobility.

The wireless communications system 100 may support techniques for L1/L2-based inter-cell mobility. For instance, the wireless communications system 100 may support the configuration and maintenance of multiple candidate cells in a configured set of cells to allow fast application of configurations for the candidate cells. Further, the wireless communications system 100 may support a dynamic switching mechanism among candidate serving cells (e.g., including an SpCell and an SCell) for potential applicable scenarios based on L1/L2 signaling. In addition, the described techniques may provide for the design and enhancement of L1/L2-based inter-cell mobility.

A procedure for L1/L2-based inter-cell mobility may be applicable in multiple scenarios. In one example, L1/L2-based inter-cell mobility may be used for standalone, CA, or NR-DC cases supporting a serving cell change within a configured grant. In another example, L1/L2-based inter-cell mobility may be used for an intra-DU case or an intra-CU and inter-DU case (e.g., applicable for standalone and CA, where no new RAN interfaces may be expected). In yet another example, L1/L2-based inter-cell mobility may be used for both intra-frequency and inter-frequency communications. In yet another example, L1/L2-based inter-cell mobility may be used for communications in both a frequency range one (FR1) and a frequency range two (FR2). In yet another example, L1/L2-based inter-cell mobility may be used for communications with source and target cells that may be synchronized or non-synchronized.

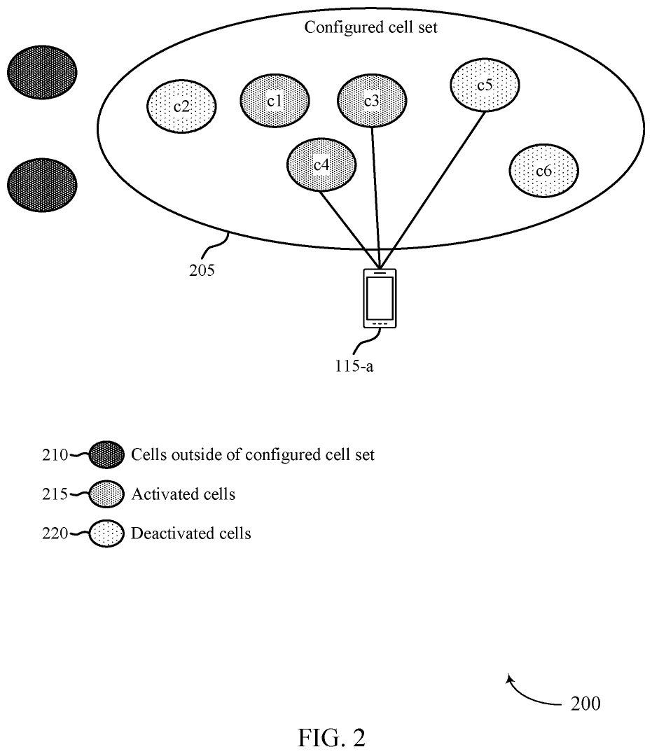

FIG. 2 illustrates an example of inter-cell mobility 200 in accordance with one or more aspects of the present disclosure. A UE 115-a may be configured with a set of cells (e.g., configured cell set 205) for inter-cell mobility (e.g., L1/L2 mobility). A network entity 105 may use RRC signaling to configure the set of cells. In some examples, there may be one or more cells 210 outside of the configured cell set 205. Cells in the configured cell set 205 may be further characterized into activated cells 215 and deactivated cells 220 (e.g., including an SpCell and SCells). An activated cell set may correspond to a group of cells that can be readily used for data and control information transfer. For example, for cells in the activated cell set, control channels may be monitored, synchronization may be maintained, or a timing advance may be maintained. A deactivated cell set may correspond to a group of cells that are not activated but can be quickly activated by L1/L2 signaling. For example, for deactivated cells, a control channel may not be monitored, synchronization may not be maintained, or a timing advance may not be maintained. The UE 115-a may perform measurements (e.g., periodically according to a configuration) on the cells in the configured cell set 205 for fast L1/L2 mobility handover. Cells in the configured cell set 205 may belong to (e.g., be supported or used for communications by) a same network entity 105 (e.g., DU) or different network entities 105 (e.g., DUs). The configured cell set 205 may be large enough to cover reasonable mobility areas, and mobility within the configured cell set may be done through L1/L2 signaling.

To facilitate inter-cell mobility using L1/L2 signaling (e.g., considering a framework for carrier aggregation), each cell in the configured cell set 205 (e.g., configured L1/L2 mobility set) may be capable of serving the UE 115-a as an SpCell or an SCell. Thus, efficient techniques for SpCell management and SCell management may enhanced efficiency in communication over the configured cell set 205. In some cases, however, techniques for supporting dynamic reconfiguration of a cell as an SpCell or an SCell may be deficient. The wireless communications system 100 may support efficient techniques for providing valid SpCell and SCell configurations for all cells in the configured cell set 205 (e.g., an L1L2Mobility related configuration in RRC to enable each cell with SpCell and SCell configurations). As such, cells may be updated by a network entity 105 (e.g., reconfigured as an SpCell or SCell) using L1/L2 signaling (e.g., compared to an SpCell or SCell being reconfigured using layer three (L3) signaling, such as RRC signaling). As mentioned, RRC signaling (e.g., L3 signaling) may update the set of cells (e.g., the configured cell set 205) for L1/L2 mobility.

In addition to the improved techniques for SpCell and SCell management, the described techniques may provide for improved techniques for cell index management. A SpCell index may be configured as zero, and an SCell index may be configured as a value ranging from one to one less than a maximum number of serving cells (e.g., a range of {1, 2, . . . , maxNrofServingCells−1}. However, when an SpCell (e.g., original SpCell) is updated to or reconfigured as an SCell, techniques for assigning an index to the reconfigured SCell may be undefined. Similarly, when an SCell is updated to or reconfigured as an SpCell and then updated back to or reconfigured back as an SCell, techniques for assigning an index to the reconfigured SCell may be undefined. The wireless communications system 100 may support efficient techniques for cell index management to support dynamic reconfiguration of a cell as an SpCell or an SCell (e.g., cell index management techniques when an SpCell or an SCell is updated by a network entity 105 using L1/L2 signaling).

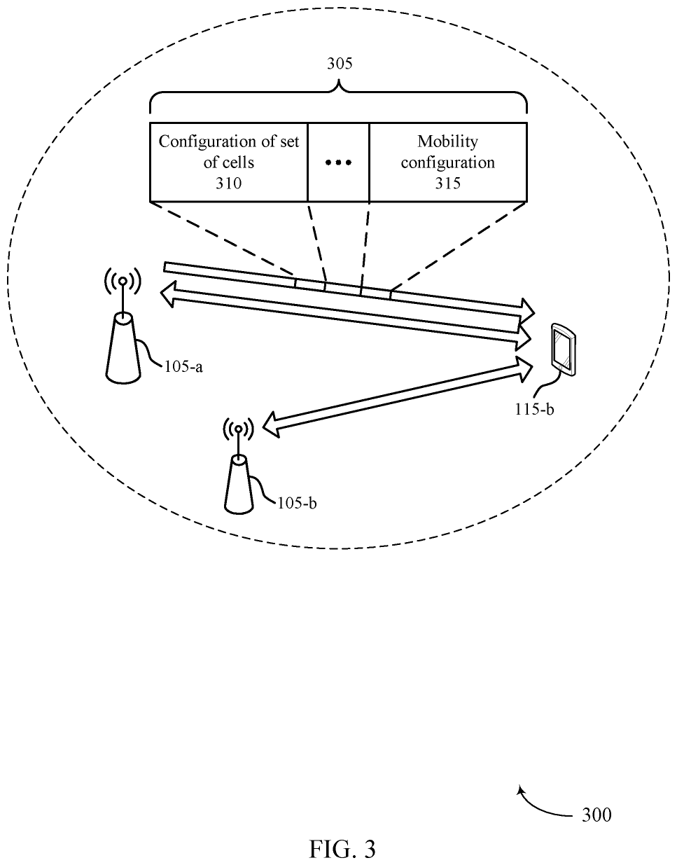

FIG. 3 illustrates an example of a wireless communications system 300 that supports cell management for inter-cell mobility in accordance with one or more aspects of the present disclosure. The wireless communications system 300 includes a UE 115-b, which may be an example of a UE 115 described with reference to FIGS. 1 and 2. The wireless communications system 300 also includes a cell 105-a and a cell 105-b, which may be an example of a network entity 105 or a cell described with reference to FIGS. 1 and 2. The wireless communications system 300 may implement aspects of the wireless communications system 100. For instance, the wireless communications system 300 may support efficient techniques for providing valid SpCell and SCell configurations for all cells in a configured cell set.

The wireless communications system 300 may utilize existing CA configuration elements with additional configurations to facilitate L1/L2 mobility within a configured CA cell set. An L1/L2 mobility configured set may be a subset of a whole CA set or may encompass the whole CA set. Each cell in the whole CA set may be individually configured with a mobility configuration 315 (e.g., an L1/L2 mobility configuration). For instance, the UE 115-b may receive an indication of a configuration 310 of a set of cells from the cell 105-a (e.g., from a network entity 105 via the cell 105-a), and the UE 115-b may receive an indication of whether each cell in the set of cells is configured for L1/L2 mobility (e.g., configured to be activated or deactivated with L1/L2 signaling or reconfigured as an SpCell or an SCell with L1/L2 signaling). The configuration 310 of the set of cells may allow for L1/L2 mobility configuration at a same time that CA is configured and upon CA reconfiguration.

The UE 115-b may receive a higher layer control message 305 (e.g., L3 signaling, RRC signaling, or an RRC configuration message) including an indication of a configuration 310 of a set of cells and an indication of applicable SpCell and SCell configurations for all cells in the configured cell set.

The indication of the configuration 310 of the set of cells may be included in a cell group configuration, and the cell group configuration may include a cell group identifier (ID), an indication of RLC bearers to add, an indication of RLC bearers to release, a MAC cell group configuration, a physical cell group configuration, an SpCell configuration, an indication of SCells to add to a configured cell set, and an indication of SCells to release from a configured cell set. The indication of the SCells to add may include one or more indices of SCells to add, and the higher layer control message 305 may also include at least an SCell configuration for each SCell for the UE 115-b to add. The SCell configuration (e.g., SCellConfig) may include an SCell index, an SCellConfigCommon information element (IE), and an sCellConfigDedicated IE. The SCellConfigCommon IE and the sCellConfigDedicated IE may configure parameters for communicating with a serving cell. These parameters may include a physical cell ID of the serving cell, parameters for uplink and downlink communications with the serving cell, a timing advance for communicating with the serving cell, resources for monitoring for reference signals from the serving cell, etc.

The indication of applicable SpCell and SCell configurations for all cells in the configured cell set may be at least partially included in a mobility configuration 315 (e.g., L1/L2 mobility configuration) within a serving cell configuration (e.g., ServingCellConfigIE). A serving cell configuration may be included in an SpCell configuration or an SCell configuration. Mobility configuration 315 (e.g., in the serving cell configuration) may contain at least an SpCell configuration for an SCell or an SCell configuration for an SpCell. The mobility configuration 315 may also contain an L1 measurement configuration for a deactivated state (e.g., a measurement configuration for the UE 115-b to perform measurements on a deactivated cell). The mobility configuration 315 may include fields (e.g., IEs) similar to an SpCell configuration (e.g., SpCellConfig) and an SCell configuration (e.g., SCellConfig). In some cases, a network entity 105 may provide (e.g., in a mobility configuration 315) more than one SpCell or SCell configuration for a cell (e.g., a list of configurations), and the network entity 105 may indicate, in L1/L2 signaling, a configuration from the list that the UE 115-b is to use to communicate with the cell. An SCell configuration may apply if a cell is updated from an SpCell to an SCell by an L1/L2 mobility procedure, and an SpCell configuration may apply if a cell is updated from an SCell to an SpCell by an L1/L2 mobility procedure.

In one aspect, if a serving cell is configured as an SpCell, a mobility configuration 315 may include an SCell configuration, and if a serving cell is configured as an SCell, a mobility configuration 315 may include an SpCell configuration. In this aspect, a mobility configuration or a format of a mobility configuration (e.g., fields included in the mobility configuration) may be cell-specific.

In another aspect, a mobility configuration 315 may include an SpCell configuration and an SCell configuration for each serving cell (e.g., all serving cells may have an SpCell configuration and an SCell configuration in mobility configurations). In this aspect, a mobility configuration or a format of a mobility configuration may be the same for all cells (e.g., all cells may have the same mobility configuration, or all cells may have an SpCell configuration and an SCell configuration).

If a mobility configuration 315 includes an SpCell configuration and an SCell configuration for a cell, a network entity 105 may indicate (e.g., together with SpCell activation or deactivation L1/L2 signaling) which configuration the UE 115-b is to apply for communicating with the cell. When an original SpCell (e.g., an SpCell that has not been reconfigured) is updated to an SCell and back to an SpCell (e.g., reconfigured SpCell), the last SpCell configuration (e.g., for the reconfigured SpCell) may be the same as the old SpCell configuration or the SpCell configuration specified in an L1/L2 mobility configuration. The old SpCell configuration may refer to another SpCell configuration provided to the UE 115-b which the UE 115-b may use to communicate with the original SpCell. When an original SCell (e.g., an SCell that has not been reconfigured) is updated to an SpCell and back to an SCell (e.g., reconfigured SCell), the last SCell configuration (e.g., for the reconfigured SCell) may be the same as the old SCell configuration or the SCell configuration specified in an L1/L2 mobility configuration. The old SCell configuration may refer to another SCell configuration provided to the UE 115-b which the UE 115-b may use to communicate with the original SCell.

In addition to techniques for SpCell or SCell configuration management, the wireless communications system 300 may support efficient techniques for cell index management (e.g., serving cell index updating) to support dynamic reconfiguration of a cell as an SpCell or an SCell.

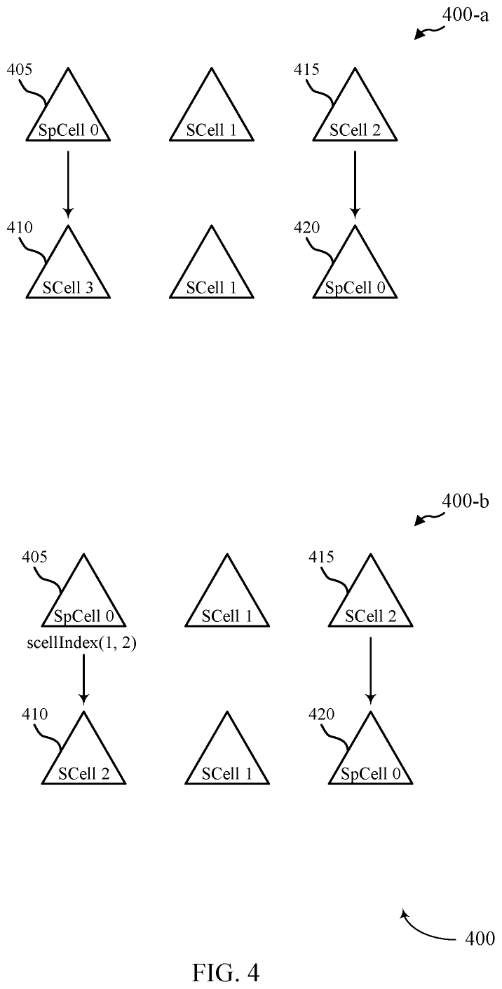

FIG. 4 illustrates an example of a cell index management 400 in accordance with one or more aspects of the present disclosure.

For a mobility configuration that is cell specific, if a serving cell is an SpCell, the mobility configuration may include an SCell configuration (e.g., only an SCell configuration), and, if a serving cell is an SCell, the mobility configuration may include an SpCell configuration (e.g., only the SpCell configuration). For an SpCell 405, there may be one or more techniques to assign an SCell index for the SpCell 405 in case the SpCell 405 is updated to an SCell 410.

In a first example 400-a, an SCell index for the SCell 410 may be included in an SCell configuration in a mobility configuration for the SpCell 405. The SCell index may be unique as compared to other existing SCells. For instance, the SCell index of the SCell 410 may be three, which may be different from the SCell indices of one and two configured for other existing SCells. If, however, a network entity 105 configures a maximum number of serving cells (e.g., one SpCell and (maxNrofServingCells−1) SCells), an SCell index of an SCell (e.g., configured for an SpCell) may have a value larger than (maxNrofServingCells−1). Thus, the network entity 105 may use one more bit to represent the cell index of the SCell. For instance, if maxNrofServingCells=32, five bits may be used to represent cell indices 0, . . . , 31. Thus, if one SpCell and 31 SCells are already configured by a network entity 105, an additional SCell index in a mobility configuration for an SpCell may have a value that is greater than 31 (e.g., 32), and the total bits used to represent cell indices may be six.

In a second example 400-b, an SCell index for the SCell 410 may be configured as a range in a mobility configuration for the SpCell 405 (e.g., a range of (1,maxNrofServingCells−1)). The range configured for the SCell 410 may include SCell indices one and two (e.g., a range of (1, 2)). A network entity 105 may use L1/L2 signaling to select an SCell index (e.g., from the configured range) for the SCell 410 together with the update signaling reconfiguring the SpCell 405 as the SCell 410. Because the network entity 105 may be able to identify that the SCell 415 is being updated to an SpCell 420 (e.g., which SCell is becoming the new SpCell) at the same time that the SpCell 405 (e.g., old SpCell) is updated to the SCell 410, the network entity 105 may signal the SpCell 405 to take the cell index of the SCell 415 (e.g., the old SCell) when the SpCell 405 is updated to the SCell 410.

For an SCell 415 being updated to an SpCell 420, the default index of the SpCell 420 may be zero. As described with reference to the second example 400-b, the SCell index for the SCell 410 may take the cell index of the SCell 415 (e.g., the SCell index for the SCell 410 may be two). In other examples (e.g., in the first example 400-a), the SCell index for the SCell 415 may become invalid after the SCell 415 is reconfigured as the SpCell 420. For instance, the originally configured SCell index becomes invalid. The SCell index for the SCell 415 may become valid again when the SpCell 420 is reconfigured as an SCell. For instance, the originally configured SCell index may become valid again when an original SCell reconfigured as an SpCell is updated from the SpCell back to an SCell (e.g., the original SCell may be reassigned to the originally configured SCell index).

As described, in some cases, a mobility configuration may include a SpCell configuration and an SCell configuration for any cell. For a SpCell, an SCell index may be included in an SCell configuration in a mobility configuration for the SpCell. Alternatively, an SCell index may be configured as a range in a mobility configuration for the SpCell (e.g., a range of (1,maxNrofServingCells−1)), and a network entity 105 may use L1/L2 signaling to select an SCell index (e.g., from the configured range) for an SCell together with the update signaling reconfiguring the SpCell as the SCell. For an SCell, when an SCell is updated to a SpCell and then updated back to an SCell (e.g., SCell_t1 is updated to PCell_t2 then updated to SCell_t3), there may be one or more techniques to assign an SCell index to the SCell. SCell_t may denote a cell configured as an SCell at a time t, and PCell_t may denote a cell configured as a SpCell at a time t. In one example, SCell_t3 may take the index (e.g., an old index) of SCell_t1. In another example, SCell_t3 may take the index specified in an SCell configuration in a mobility configuration. In yet another example, a network entity 105 may transmit, and a UE 115 may receive, L1/L2 signaling indicating whether an SCell index for SCell_t3 is the same as an SCell index for SCell_t1 or whether an SCell index for SCell_t3 is the SCell index specified in an SCell configuration in a mobility configuration.

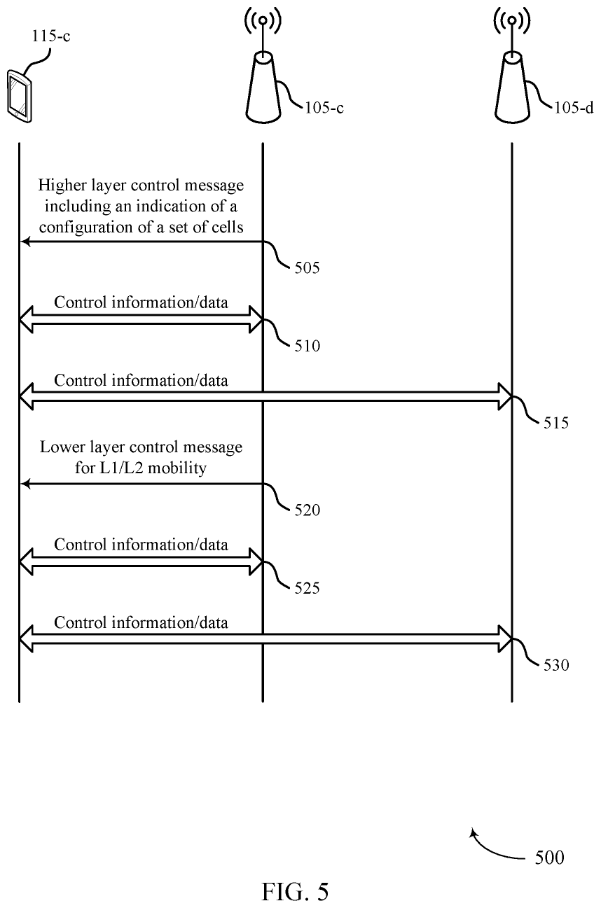

FIG. 5 illustrates an example of a process flow 500 that supports cell management for inter-cell mobility in accordance with one or more aspects of the present disclosure. The process flow 500 includes a UE 115-c, which may be an example of a UE 115 described with reference to FIGS. 1-4. The process flow 500 also includes a first cell 105-c and a second cell 105-d, which may be examples of network entities 105 or cells described with reference to FIGS. 1-4. The process flow 500 may implement aspects of the wireless communications system 100 or the wireless communications system 300. For instance, the process flow 500 may support efficient techniques for providing valid SpCell and SCell configurations to a UE 115-c for all cells in a configured cell set. The process flow 500 may also support efficient techniques for cell index management to support dynamic reconfiguration of a cell as a SpCell or an SCell.

A configuration for a cell may include one or more parameters for communicating with the cell. For instance, a configuration for a cell may include a physical cell ID of the cell, parameters for uplink and downlink communications with the serving cell (e.g., resources to use for uplink and downlink communications), a timing advance for communicating with the cell, resources for monitoring for reference signals from the serving cell, etc. In some cases, the UE 115-c may also receive a measurement configuration for performing measurements on reference signals received from a deactivated cell, and the measurement configuration may indicate resources to monitor for the reference signals, a type of the reference signals, etc. for the UE 115-c to use to perform the measurements.

In the following description of the process flow 500, the signaling exchanged between the UE 115-c, the cell 105-c, and the cell 105-d may be exchanged in a different order than the example order shown, or the operations performed by the UE 115-c, the cell 105-c, and the cell 105-d may be performed in different orders or at different times. Some operations may also be omitted from the process flow 500, and other operations may be added to the process flow 500.

At 505, a network entity 105 may transmit a higher layer control message to a UE 115-c via a first cell 105-c, and the UE 115-c may receive the higher layer control message. The higher layer control message may include a configuration of a set of cells with which the UE 115-c may communicate, and the set of cells may include the first cell 105-c and a second cell 105-d. The first cell 105-c may be configured as a SpCell at a first time, and the second cell 105-d may be configured as an SCell at the first time. The higher layer control message may include a first SpCell configuration for the first cell 105-c and a first SCell configuration for the second cell 105-d. The higher layer control message may also include (e.g., in a mobility configuration) an SCell configuration for the first cell 105-c and a SpCell configuration for the second cell 105-d. In some examples, the higher layer control message may include multiple SCell configurations for the first cell 105-c and multiple SpCell configurations for the second cell 105-d.

At 510, the UE 115-c may communicate, at or after the first time, with the first cell 105-c in accordance with the first SpCell configuration for the first cell 105-c, and, at 515, the UE 115-c may communicate, at or after the first time, with the second cell 105-d in accordance with the first SCell configuration for the second cell 105-d. In some examples, the UE 115-c may receive an indication of a measurement configuration for performing measurements on reference signals received from a deactivated cell in a configured cell set, and the UE 115-c may perform measurements on the reference signals in accordance with the measurement configuration.

At 520, a network entity 105 may transmit a lower layer control message (e.g., L1 or L2 control message, such as a DCI message or a MAC-CE) to the UE 115-c via the first cell 105-c, and the UE 115-c may receive the lower layer control message. The lower layer control message may support L1/L2 mobility, where one or more cells in a configured cell set may be activated or deactivated or reconfigured as a SpCell or an SCell. For instance, the lower layer control message may configure the first cell 105-c as an SCell at a second time and configure the second cell 105-d as a SpCell at the second time. At 525, the UE 115-c may communicate, at or after the second time, with the first cell 105-c in accordance with the SCell configuration for the first cell 105-c, and, at 530, the UE 115-c may communicate, at or after the second time, with the second cell 105-d in accordance with the SpCell configuration for the second cell 105-d. If the higher layer control message indicates multiple SCell configurations for the first cell 105-c and multiple SpCell configurations for the second cell 105-d, the lower layer control message may indicate the SCell configuration for the first cell 105-c from the multiple SCell configurations and the SpCell configuration for the second cell 105-d from the multiple SpCell configurations.

In some aspects, the higher layer control message may also include a second SpCell configuration for the first cell 105-c and a second SCell configuration for the second cell 105-d. In such aspects, the UE 115-c may determine whether to communicate with the first cell 105-c using the first SpCell configuration or the second SpCell configuration after the first cell 105-c is reconfigured from an SCell back to a SpCell at a third time. In one example, the UE 115-c may communicate, at or after the third time, with the first cell 105-c in accordance with the first SpCell configuration for the first cell 105-c, and the UE 115-c may communicate, at or after the third time, with the second cell 105-d in accordance with the first SCell configuration for the second cell 105-d. In another example, the UE 115-c may communicate, at or after the third time, with the first cell 105-c in accordance with the second SpCell configuration for the first cell 105-c, and the UE 115-c may communicate, at or after the third time, with the second cell 105-d in accordance with the second SCell configuration for the second cell 105-d. In yet another example, the UE 115-c may receive an indication of whether to communicate, at or after the third time, with the first cell 105-c in accordance with the first SpCell configuration or the second SpCell configuration, and the UE 115-c may receive an indication of whether to communicate, at or after the third time, with the second cell 105-d in accordance with the first SCell configuration or the second SCell configuration. The UE 115-c may receive such indications in a second lower layer control message used to reconfigure the first cell 105-c back to a SpCell and reconfigure the second cell 105-d back to an SCell. The UE 115-c may then communicate, at or after the third time, with the first cell 105-c and the second cell 105-d in accordance with the second lower layer control message. For instance, if the second lower layer control message indicates that the UE 115-c is to use the first SpCell configuration to communicate with the first cell 105-c, the UE 115-c may communicate with the first cell 105-c using the first SpCell configuration. Alternatively, if the second lower layer control message indicates that the UE 115-c is to use the second SpCell configuration to communicate with the first cell 105-c, the UE 115-c may communicate with the first cell 105-c using the second SpCell configuration. Similarly, if the second lower layer control message indicates that the UE 115-c is to use the first SCell configuration to communicate with the second cell 105-d, the UE 115-c may communicate with the second cell 105-d using the first SCell configuration. Alternatively, if the second lower layer control message indicates that the UE 115-c is to use the second SCell configuration to communicate with the second cell 105-d, the UE 115-c may communicate with the second cell 105-d using the second SCell configuration.

In some examples, the higher layer control message may indicate an SCell index for the first cell 105-c, where the SCell index is different from SCell indices for other cells in a configured cell set. In some examples, the higher layer control message may indicate a range of SCell indices for the first cell 105-c, and the lower layer control message may indicate an SCell index for the first cell 105-c (e.g., at the second time), where the SCell index is selected from the range of SCell indices. In some examples, a SpCell index for the second cell 105-d is zero at the second time, and an SCell index for the second cell 105-d is invalid at the second time. In some examples, after the second lower layer control message configures the second cell 105-d as an SCell at the third time, an SCell index of the second cell 105-d at the third time may include or be the same as an SCell index of the second cell 105-d at the first time. In some examples, the UE 115-c may receive an indication of an SCell index for the second cell 105-d (e.g., in the higher layer control message), and, after the second lower layer control message configures the second cell 105-d as an SCell at the third time, an SCell index of the second cell 105-d at the third time may be the indicated SCell index.

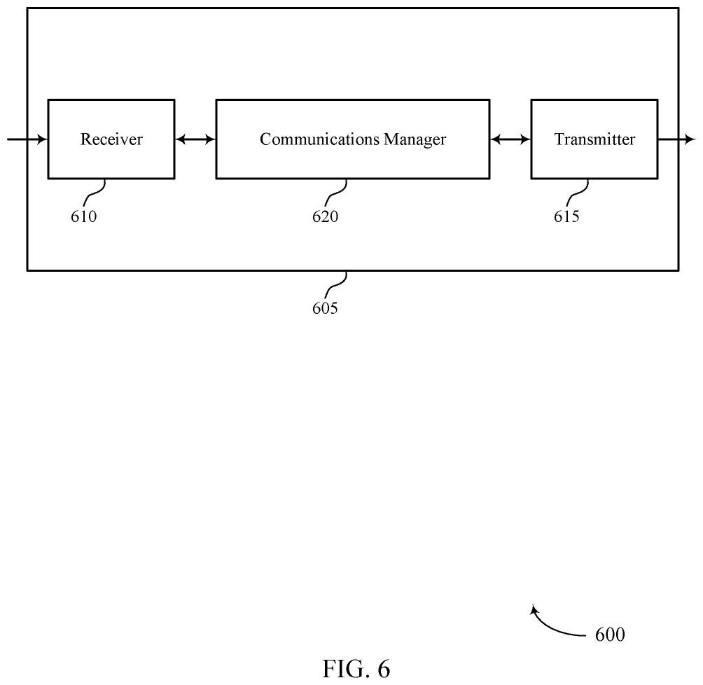

FIG. 6 shows a block diagram 600 of a device 605 that supports cell management for inter-cell mobility in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to cell management for inter-cell mobility). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to cell management for inter-cell mobility). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of cell management for inter-cell mobility as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for receiving an indication of a configuration of a set of cells, the configuration including a secondary cell configuration for a first cell of the set of cells that is configured as a special cell at a first time and a special cell configuration for a second cell of the set of cells that is configured as a secondary cell at the first time. The communications manager 620 may be configured as or otherwise support a means for receiving a control message configuring the first cell as a secondary cell at a second time and configuring the second cell as a special cell at the second time. The communications manager 620 may be configured as or otherwise support a means for communicating, after the second time, with the first cell in accordance with the secondary cell configuration for the first cell and with the second cell in accordance with the special cell configuration for the second cell.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources. Because the device 605 may be able to identify an SCell configuration for a SpCell and a SpCell configuration for an SCell, and the device 605 may support efficient techniques for cell index management, the device 605 may be able to efficiently communicate with one or more cells in a configured cell set. As a result, the device 605 may avoid wasting power and processing resources on communicating with suboptimal cells or using suboptimal configurations for communicating with cells in the configured cell set, and the device 605 may maximize resource utilization.

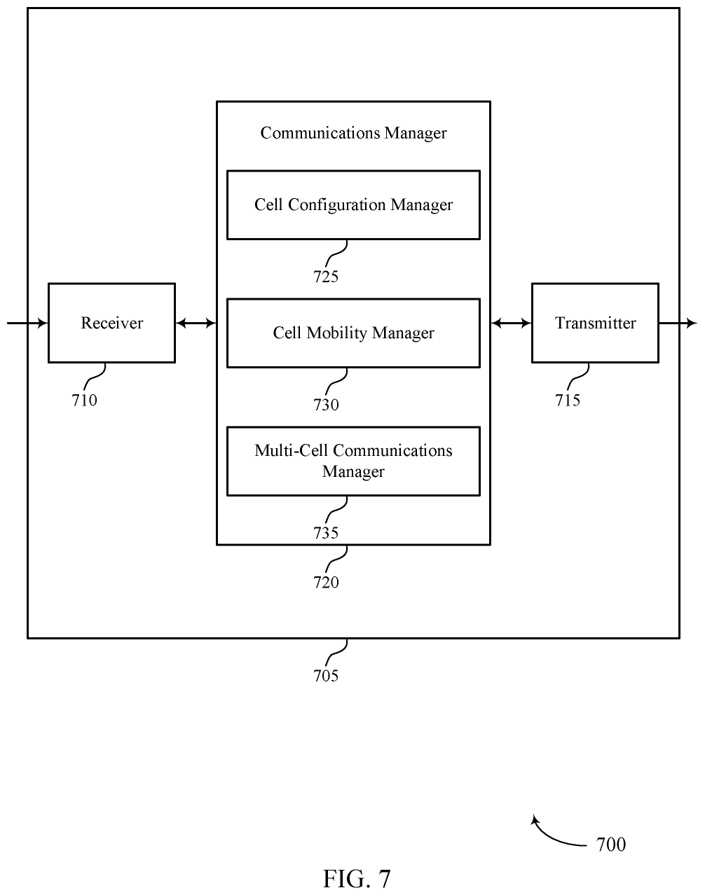

FIG. 7 shows a block diagram 700 of a device 705 that supports cell management for inter-cell mobility in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to cell management for inter-cell mobility). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to cell management for inter-cell mobility). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of cell management for inter-cell mobility as described herein. For example, the communications manager 720 may include a cell configuration manager 725, a cell mobility manager 730, a multi-cell communications manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The cell configuration manager 725 may be configured as or otherwise support a means for receiving an indication of a configuration of a set of cells, the configuration including a secondary cell configuration for a first cell of the set of cells that is configured as a special cell at a first time and a special cell configuration for a second cell of the set of cells that is configured as a secondary cell at the first time. The cell mobility manager 730 may be configured as or otherwise support a means for receiving a control message configuring the first cell as a secondary cell at a second time and configuring the second cell as a special cell at the second time. The multi-cell communications manager 735 may be configured as or otherwise support a means for communicating, after the second time, with the first cell in accordance with the secondary cell configuration for the first cell and with the second cell in accordance with the special cell configuration for the second cell.

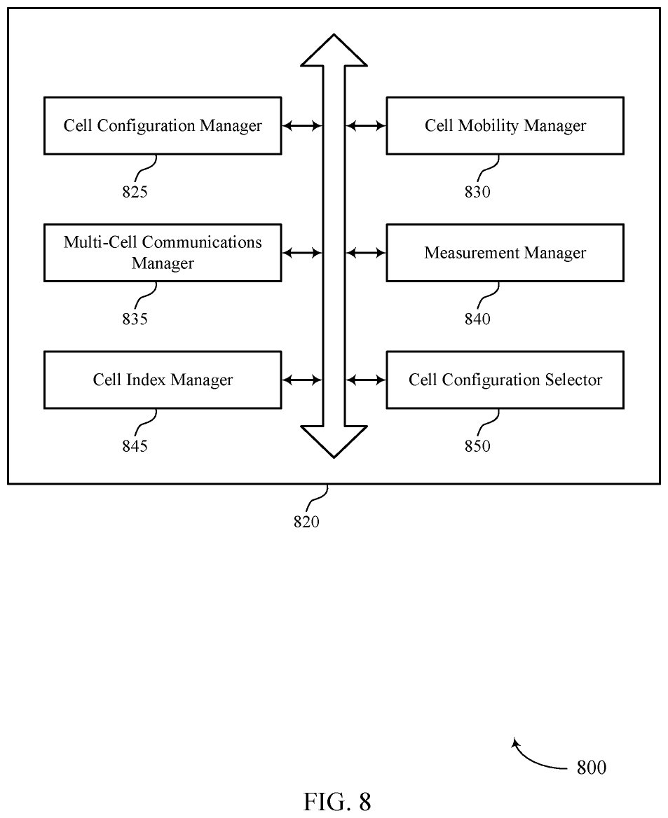

FIG. 8 shows a block diagram 800 of a communications manager 820 that supports cell management for inter-cell mobility in accordance with one or more aspects of the present disclosure. The communications manager 820 may be an example of aspects of a communications manager 620, a communications manager 720, or both, as described herein. The communications manager 820, or various components thereof, may be an example of means for performing various aspects of cell management for inter-cell mobility as described herein. For example, the communications manager 820 may include a cell configuration manager 825, a cell mobility manager 830, a multi-cell communications manager 835, a measurement manager 840, a cell index manager 845, a cell configuration selector 850, or any combination thereof. Each of these components may communicate, directly or indirectly, with one another (e.g., via one or more buses).

The communications manager 820 may support wireless communication at a UE in accordance with examples as disclosed herein. The cell configuration manager 825 may be configured as or otherwise support a means for receiving an indication of a configuration of a set of cells, the configuration including a secondary cell configuration for a first cell of the set of cells that is configured as a special cell at a first time and a special cell configuration for a second cell of the set of cells that is configured as a secondary cell at the first time. The cell mobility manager 830 may be configured as or otherwise support a means for receiving a control message configuring the first cell as a secondary cell at a second time and configuring the second cell as a special cell at the second time. The multi-cell communications manager 835 may be configured as or otherwise support a means for communicating, after the second time, with the first cell in accordance with the secondary cell configuration for the first cell and with the second cell in accordance with the special cell configuration for the second cell.

In some examples, the cell configuration manager 825 may be configured as or otherwise support a means for receiving an indication of a first special cell configuration for the first cell and a first secondary cell configuration for the second cell. In some examples, the multi-cell communications manager 835 may be configured as or otherwise support a means for communicating, after the first time, with the first cell in accordance with the first special cell configuration for the first cell and with the second cell in accordance with the first secondary cell configuration for the second cell.

In some examples, the cell configuration manager 825 may be configured as or otherwise support a means for receiving an indication of a second special cell configuration for the first cell and a second secondary cell configuration for the second cell. In some examples, the multi-cell communications manager 835 may be configured as or otherwise support a means for communicating, after a third time, with the first cell in accordance with the second special cell configuration for the first cell and with the second cell in accordance with the second secondary cell configuration for the second cell.

In some examples, the cell configuration manager 825 may be configured as or otherwise support a means for receiving an indication of a second special cell configuration for the first cell and a second secondary cell configuration for the second cell. In some examples, the multi-cell communications manager 835 may be configured as or otherwise support a means for communicating, after a third time, with the first cell in accordance with the first special cell configuration for the first cell and with the second cell in accordance with the first secondary cell configuration for the second cell.

In some examples, the cell configuration manager 825 may be configured as or otherwise support a means for receiving an indication of a second special cell configuration for the first cell and a second secondary cell configuration for the second cell. In some examples, the cell configuration selector 850 may be configured as or otherwise support a means for receiving, in a second control message, an indication of whether to communicate, after a third time, with the first cell in accordance with the first special cell configuration for the first cell or the second special cell configuration for the first cell. In some examples, the cell configuration selector 850 may be configured as or otherwise support a means for receiving, in the second control message, an indication of whether to communicate, after the third time, with the second cell in accordance with the first secondary cell configuration for the second cell or the second secondary cell configuration for the second cell. In some examples, the multi-cell communications manager 835 may be configured as or otherwise support a means for communicating, after the third time, with the first cell and the second cell in accordance with the second control message.

In some examples, to support receiving the indication of the secondary cell configuration for the first cell and the special cell configuration for the second cell, the cell configuration manager 825 may be configured as or otherwise support a means for receiving an indication of a set of multiple secondary cell configurations for the first cell and a set of multiple special cell configurations for the second cell, where the control message indicates the secondary cell configuration for the first cell from the set of multiple secondary cell configurations and the special cell configuration for the second cell from the set of multiple special cell configurations.

In some examples, the secondary cell configuration for the first cell and the special cell configuration for the second cell are received in a mobility configuration.

In some examples, the measurement manager 840 may be configured as or otherwise support a means for receiving an indication of a measurement configuration for performing measurements on reference signals received from each deactivated cell of the set of cells.

In some examples, the cell index manager 845 may be configured as or otherwise support a means for receiving an indication of a secondary cell index for the first cell, where the secondary cell index for the first cell is different from secondary cell indices for other cells in the set of cells configured for communications with the UE.

In some examples, the cell index manager 845 may be configured as or otherwise support a means for receiving an indication of a range of secondary cell indices for the first cell, where the control message includes an indication of a secondary cell index for the first cell at the second time, the secondary cell index selected from the range of secondary cell indices for the first cell.

In some examples, a special cell index for the second cell is zero at the second time, and a secondary cell index for the second cell is invalid at the second time.

In some examples, the cell configuration manager 825 may be configured as or otherwise support a means for receiving a second control message configuring the second cell as a secondary cell at a third time, where a secondary cell index of the second cell at the third time includes a secondary cell index of the second cell at the first time.

In some examples, the cell index manager 845 may be configured as or otherwise support a means for receiving an indication of a secondary cell index for the second cell. In some examples, the cell configuration manager 825 may be configured as or otherwise support a means for receiving a second control message configuring the second cell as a secondary cell at a third time, where a secondary cell index of the second cell at the third time includes the indicated secondary cell index.

In some examples, the control message includes a layer one or layer two control message.

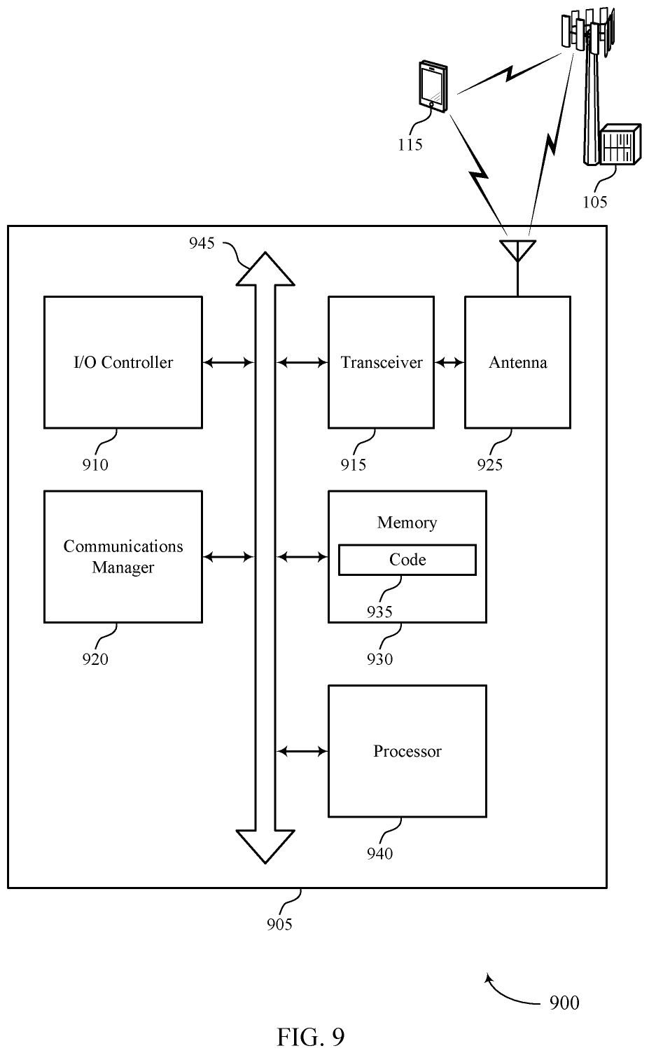

FIG. 9 shows a diagram of a system 900 including a device 905 that supports cell management for inter-cell mobility in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting cell management for inter-cell mobility). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving an indication of a configuration of a set of cells, the configuration including a secondary cell configuration for a first cell of the set of cells that is configured as a special cell at a first time and a special cell configuration for a second cell of the set of cells that is configured as a secondary cell at the first time. The communications manager 920 may be configured as or otherwise support a means for receiving a control message configuring the first cell as a secondary cell at a second time and configuring the second cell as a special cell at the second time. The communications manager 920 may be configured as or otherwise support a means for communicating, after the second time, with the first cell in accordance with the secondary cell configuration for the first cell and with the second cell in accordance with the special cell configuration for the second cell.

By including or configuring the communications manager 920 in accordance with examples as described herein, the device 905 may support techniques for reduced processing, reduced power consumption, and more efficient utilization of communication resources. Because the device 905 may be able to identify an SCell configuration for a SpCell and a SpCell configuration for an SCell, and the device 905 may support efficient techniques for cell index management, the device 905 may be able to efficiently communicate with one or more cells in a configured cell set. As a result, the device 905 may avoid wasting power and processing resources on communicating with suboptimal cells or using suboptimal configurations for communicating with cells in the configured cell set, and the device 905 may maximize resource utilization.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of cell management for inter-cell mobility as described herein, or the processor 940 and the memory 930 may be otherwise configured to perform or support such operations.

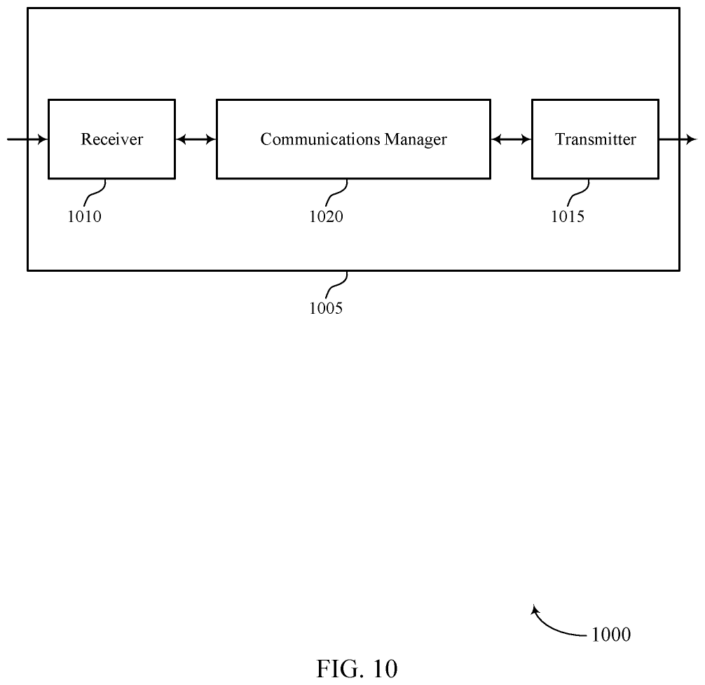

FIG. 10 shows a block diagram 1000 of a device 1005 that supports cell management for inter-cell mobility in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of cell management for inter-cell mobility as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 may be configured as or otherwise support a means for transmitting, to a UE, an indication of a configuration of a set of cells, the configuration including a secondary cell configuration for a first cell of the set of cells that is configured as a special cell at a first time and a special cell configuration for a second cell of the set of cells that is configured as a secondary cell at the first time. The communications manager 1020 may be configured as or otherwise support a means for transmitting, to the UE, a control message configuring the first cell as a secondary cell at a second time and configuring the second cell as a special cell at the second time. The communications manager 1020 may be configured as or otherwise support a means for communicating, after the second time, with the UE via the first cell in accordance with the secondary cell configuration for the first cell and with the UE via the second cell in accordance with the special cell configuration for the second cell.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources. Because the device 1005 may provide, to a UE, an SCell configuration for a SpCell and a SpCell configuration for an SCell, and the device 1005 may assist the UE in cell index management, the device 1005 may facilitate efficient communications between the UE and one or more cells in a configured cell set. As a result, the device 1005 may avoid wasting power and processing resources on facilitating communications at the UE with suboptimal cells or facilitating communications at the UE using suboptimal configurations, and the device 1005 may maximize resource utilization.

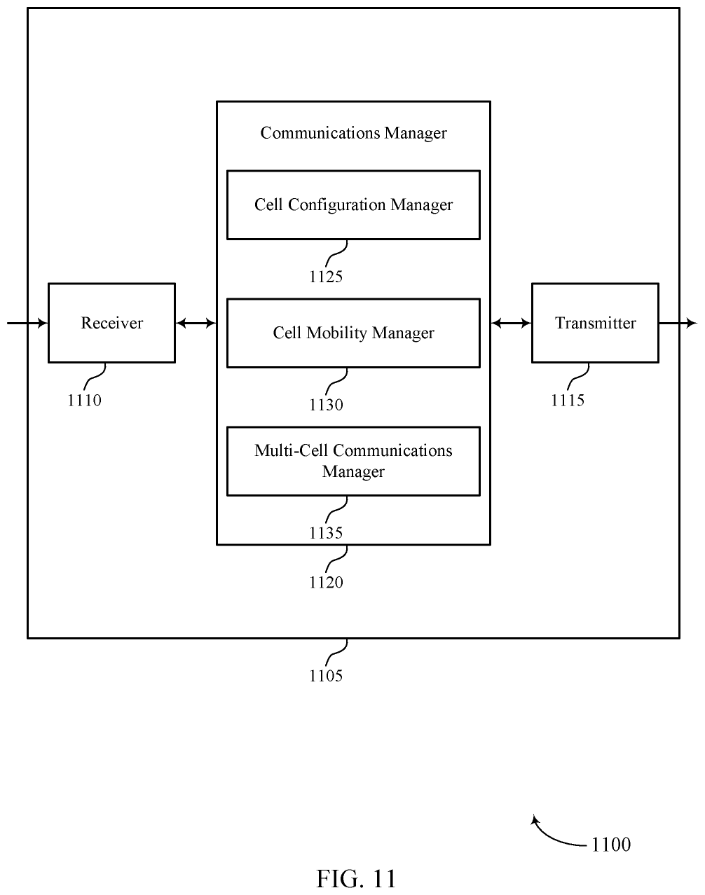

FIG. 11 shows a block diagram 1100 of a device 1105 that supports cell management for inter-cell mobility in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of cell management for inter-cell mobility as described herein. For example, the communications manager 1120 may include a cell configuration manager 1125, a cell mobility manager 1130, a multi-cell communications manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The cell configuration manager 1125 may be configured as or otherwise support a means for transmitting, to a UE, an indication of a configuration of a set of cells, the configuration including a secondary cell configuration for a first cell of the set of cells that is configured as a special cell at a first time and a special cell configuration for a second cell of the set of cells that is configured as a secondary cell at the first time. The cell mobility manager 1130 may be configured as or otherwise support a means for transmitting, to the UE, a control message configuring the first cell as a secondary cell at a second time and configuring the second cell as a special cell at the second time. The multi-cell communications manager 1135 may be configured as or otherwise support a means for communicating, after the second time, with the UE via the first cell in accordance with the secondary cell configuration for the first cell and with the UE via the second cell in accordance with the special cell configuration for the second cell.

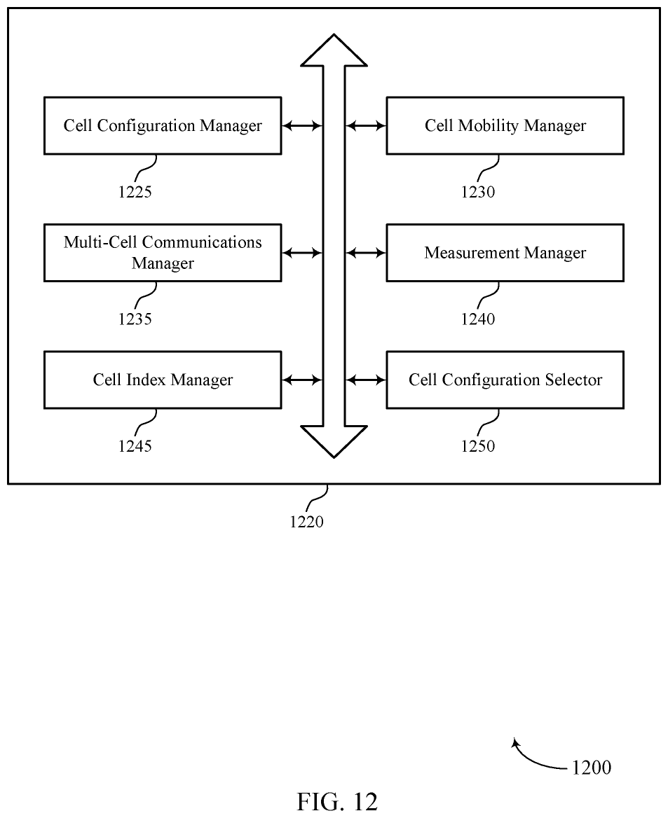

FIG. 12 shows a block diagram 1200 of a communications manager 1220 that supports cell management for inter-cell mobility in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of cell management for inter-cell mobility as described herein. For example, the communications manager 1220 may include a cell configuration manager 1225, a cell mobility manager 1230, a multi-cell communications manager 1235, a measurement manager 1240, a cell index manager 1245, a cell configuration selector 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The cell configuration manager 1225 may be configured as or otherwise support a means for transmitting, to a UE, an indication of a configuration of a set of cells, the configuration including a secondary cell configuration for a first cell of the set of cells that is configured as a special cell at a first time and a special cell configuration for a second cell of the set of cells that is configured as a secondary cell at the first time. The cell mobility manager 1230 may be configured as or otherwise support a means for transmitting, to the UE, a control message configuring the first cell as a secondary cell at a second time and configuring the second cell as a special cell at the second time. The multi-cell communications manager 1235 may be configured as or otherwise support a means for communicating, after the second time, with the UE via the first cell in accordance with the secondary cell configuration for the first cell and with the UE via the second cell in accordance with the special cell configuration for the second cell.

In some examples, the cell configuration manager 1225 may be configured as or otherwise support a means for transmitting an indication of a first special cell configuration for the first cell and a first secondary cell configuration for the second cell. In some examples, the multi-cell communications manager 1235 may be configured as or otherwise support a means for communicating, after the first time, with the UE via the first cell in accordance with the first special cell configuration for the first cell and with the UE via the second cell in accordance with the first secondary cell configuration for the second cell.

In some examples, the cell configuration manager 1225 may be configured as or otherwise support a means for transmitting an indication of a second special cell configuration for the first cell and a second secondary cell configuration for the second cell. In some examples, the multi-cell communications manager 1235 may be configured as or otherwise support a means for communicating, after a third time, with the UE via the first cell in accordance with the second special cell configuration for the first cell and with the UE via the second cell in accordance with the second secondary cell configuration for the second cell.

In some examples, the cell configuration manager 1225 may be configured as or otherwise support a means for transmitting an indication of a second special cell configuration for the first cell and a second secondary cell configuration for the second cell. In some examples, the multi-cell communications manager 1235 may be configured as or otherwise support a means for communicating, after a third time, with the UE via the first cell in accordance with the first special cell configuration for the first cell and with the UE via the second cell in accordance with the first secondary cell configuration for the second cell.

In some examples, the cell configuration manager 1225 may be configured as or otherwise support a means for transmitting an indication of a second special cell configuration for the first cell and a second secondary cell configuration for the second cell. In some examples, the cell configuration selector 1250 may be configured as or otherwise support a means for transmitting, in a second control message, an indication of whether the UE is to communicate, after a third time, with the first cell in accordance with the first special cell configuration for the first cell or the second special cell configuration for the first cell. In some examples, the cell configuration selector 1250 may be configured as or otherwise support a means for transmitting, in the second control message, an indication of whether the UE is to communicate, after the third time, with the second cell in accordance with the first secondary cell configuration for the second cell or the second secondary cell configuration for the second cell. In some examples, the multi-cell communications manager 1235 may be configured as or otherwise support a means for communicating, after the third time, with the UE via the first cell and the second cell in accordance with the second control message.

In some examples, to support transmitting the indication of the secondary cell configuration for the first cell and the special cell configuration for the second cell, the cell configuration manager 1225 may be configured as or otherwise support a means for transmitting an indication of a set of multiple secondary cell configurations for the first cell and a set of multiple special cell configurations for the second cell, where the control message indicates the secondary cell configuration for the first cell from the set of multiple secondary cell configurations and the special cell configuration for the second cell from the set of multiple special cell configurations.

In some examples, the secondary cell configuration for the first cell and the special cell configuration for the second cell are transmitted in a mobility configuration.

In some examples, the measurement manager 1240 may be configured as or otherwise support a means for transmitting an indication of a measurement configuration for the UE to perform measurements on reference signals received from each deactivated cell of the set of cells.

In some examples, the cell index manager 1245 may be configured as or otherwise support a means for transmitting an indication of a secondary cell index for the first cell, where the secondary cell index for the first cell is different from secondary cell indices for other cells in the set of cells configured for communications with the UE.

In some examples, the cell index manager 1245 may be configured as or otherwise support a means for transmitting an indication of a range of secondary cell indices for the first cell, where the control message includes an indication of a secondary cell index for the first cell at the second time, the secondary cell index selected from the range of secondary cell indices for the first cell.

In some examples, a special cell index for the second cell is zero at the second time, and a secondary cell index for the second cell is invalid at the second time.

In some examples, the cell configuration manager 1225 may be configured as or otherwise support a means for transmitting a second control message configuring the second cell as a secondary cell at a third time, where a secondary cell index of the second cell at the third time includes a secondary cell index of the second cell at the first time.

In some examples, the cell index manager 1245 may be configured as or otherwise support a means for transmitting an indication of a secondary cell index for the second cell. In some examples, the cell configuration manager 1225 may be configured as or otherwise support a means for transmitting a second control message configuring the second cell as a secondary cell at a third time, where a secondary cell index of the second cell at the third time includes the indicated secondary cell index.

In some examples, the control message includes a layer one or layer two control message.

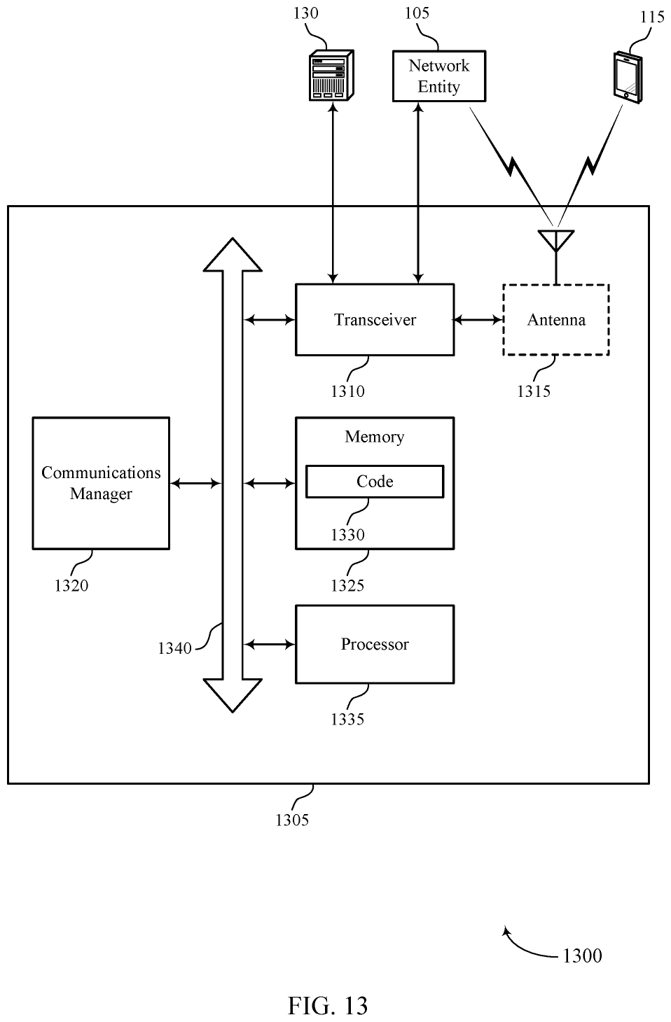

FIG. 13 shows a diagram of a system 1300 including a device 1305 that supports cell management for inter-cell mobility in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting cell management for inter-cell mobility). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and an interface to output information, or to obtain information, or both. The interface may be implemented as or otherwise include a first interface configured to output information and a second interface configured to obtain information. In some implementations, the first interface may refer to an interface between the processing system of the chip or modem and a transmitter, such that the device 1305 may transmit information output from the chip or modem. In some implementations, the second interface may refer to an interface between the processing system of the chip or modem and a receiver, such that the device 1305 may obtain information or signal inputs, and the information may be passed to the processing system. A person having ordinary skill in the art will readily recognize that the first interface also may obtain information or signal inputs, and the second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 may be configured as or otherwise support a means for transmitting, to a UE, an indication of a configuration of a set of cells, the configuration including a secondary cell configuration for a first cell of the set of cells that is configured as a special cell at a first time and a special cell configuration for a second cell of the set of cells that is configured as a secondary cell at the first time. The communications manager 1320 may be configured as or otherwise support a means for transmitting, to the UE, a control message configuring the first cell as a secondary cell at a second time and configuring the second cell as a special cell at the second time. The communications manager 1320 may be configured as or otherwise support a means for communicating, after the second time, with the UE via the first cell in accordance with the secondary cell configuration for the first cell and with the UE via the second cell in accordance with the special cell configuration for the second cell.

By including or configuring the communications manager 1320 in accordance with examples as described herein, the device 1305 may support techniques for reduced processing, reduced power consumption, and more efficient utilization of communication resources. Because the device 1305 may provide, to a UE, an SCell configuration for a SpCell and a SpCell configuration for an SCell, and the device 1305 may assist the UE in cell index management, the device 1305 may facilitate efficient communications between the UE and one or more cells in a configured cell set. As a result, the device 1305 may avoid wasting power and processing resources on facilitating communications at the UE with suboptimal cells or facilitating communications at the UE using suboptimal configurations, and the device 1305 may maximize resource utilization.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of cell management for inter-cell mobility as described herein, or the processor 1335 and the memory 1325 may be otherwise configured to perform or support such operations.

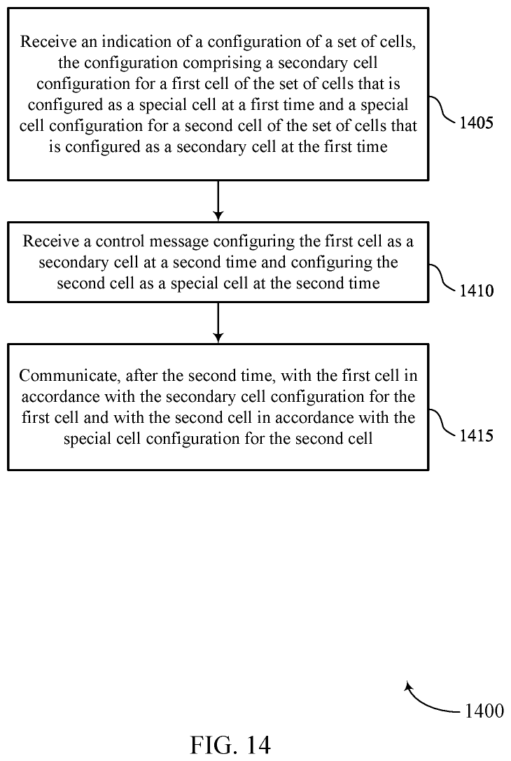

FIG. 14 shows a flowchart illustrating a method 1400 that supports cell management for inter-cell mobility in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving an indication of a configuration of a set of cells, the configuration including a secondary cell configuration for a first cell of the set of cells that is configured as a special cell at a first time and a special cell configuration for a second cell of the set of cells that is configured as a secondary cell at the first time. The operations of 1405 may be performed in accordance with examples as disclosed herein. In some examples, aspects of the operations of 1405 may be performed by a cell configuration manager 825 as described with reference to FIG. 8.

At 1410, the method may include receiving a control message configuring the first cell as a secondary cell at a second time and configuring the second cell as a special cell at the second time. The operations of 1410 may be performed in accordance with examples as disclosed herein. In some examples, aspects of the operations of 1410 may be performed by a cell mobility manager 830 as described with reference to FIG. 8.

At 1415, the method may include communicating, after the second time, with the first cell in accordance with the secondary cell configuration for the first cell and with the second cell in accordance with the special cell configuration for the second cell. The operations of 1415 may be performed in accordance with examples as disclosed herein. In some examples, aspects of the operations of 1415 may be performed by a multi-cell communications manager 835 as described with reference to FIG. 8.

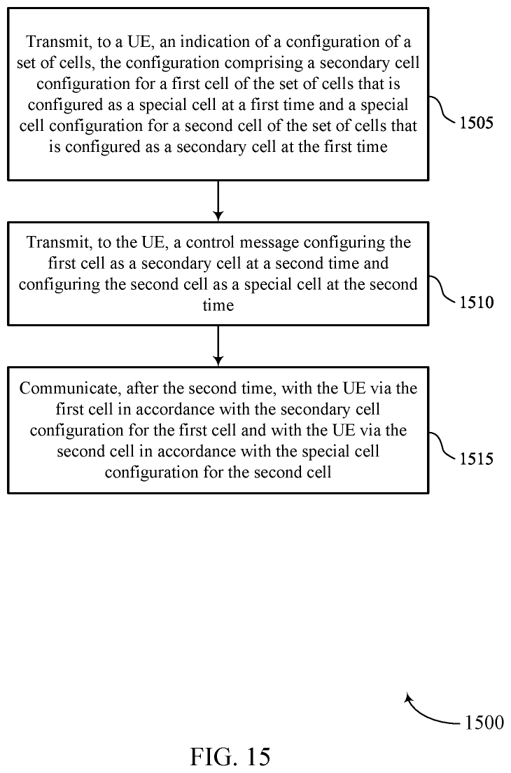

FIG. 15 shows a flowchart illustrating a method 1500 that supports cell management for inter-cell mobility in accordance with one or more aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1505, the method may include transmitting, to a UE, an indication of a configuration of a set of cells, the configuration including a secondary cell configuration for a first cell of the set of cells that is configured as a special cell at a first time and a special cell configuration for a second cell of the set of cells that is configured as a secondary cell at the first time. The operations of 1505 may be performed in accordance with examples as disclosed herein. In some examples, aspects of the operations of 1505 may be performed by a cell configuration manager 1225 as described with reference to FIG. 12.

At 1510, the method may include transmitting, to the UE, a control message configuring the first cell as a secondary cell at a second time and configuring the second cell as a special cell at the second time. The operations of 1510 may be performed in accordance with examples as disclosed herein. In some examples, aspects of the operations of 1510 may be performed by a cell mobility manager 1230 as described with reference to FIG. 12.

At 1515, the method may include communicating, after the second time, with the UE via the first cell in accordance with the secondary cell configuration for the first cell and with the UE via the second cell in accordance with the special cell configuration for the second cell. The operations of 1515 may be performed in accordance with examples as disclosed herein. In some examples, aspects of the operations of 1515 may be performed by a multi-cell communications manager 1235 as described with reference to FIG. 12.

The following provides an overview of aspects of the present disclosure:

Aspect 1: A method for wireless communication at a UE, comprising: receiving an indication of a configuration of a set of cells, the configuration comprising a secondary cell configuration for a first cell of the set of cells that is configured as a special cell at a first time and a special cell configuration for a second cell of the set of cells that is configured as a secondary cell at the first time; receiving a control message configuring the first cell as a secondary cell at a second time and configuring the second cell as a special cell at the second time; and communicating, after the second time, with the first cell in accordance with the secondary cell configuration for the first cell and with the second cell in accordance with the special cell configuration for the second cell.

Aspect 2: The method of aspect 1, further comprising: receiving an indication of a first special cell configuration for the first cell and a first secondary cell configuration for the second cell; and communicating, after the first time, with the first cell in accordance with the first special cell configuration for the first cell and with the second cell in accordance with the first secondary cell configuration for the second cell.

Aspect 3: The method of aspect 2, further comprising: receiving an indication of a second special cell configuration for the first cell and a second secondary cell configuration for the second cell; and communicating, after a third time, with the first cell in accordance with the second special cell configuration for the first cell and with the second cell in accordance with the second secondary cell configuration for the second cell.

Aspect 4: The method of any of aspects 2 through 3, further comprising: receiving an indication of a second special cell configuration for the first cell and a second secondary cell configuration for the second cell; and communicating, after a third time, with the first cell in accordance with the first special cell configuration for the first cell and with the second cell in accordance with the first secondary cell configuration for the second cell.

Aspect 5: The method of any of aspects 2 through 4, further comprising: receiving an indication of a second special cell configuration for the first cell and a second secondary cell configuration for the second cell; receiving, in a second control message, an indication of whether to communicate, after a third time, with the first cell in accordance with the first special cell configuration for the first cell or the second special cell configuration for the first cell; receiving, in the second control message, an indication of whether to communicate, after the third time, with the second cell in accordance with the first secondary cell configuration for the second cell or the second secondary cell configuration for the second cell; and communicating, after the third time, with the first cell and the second cell in accordance with the second control message.

Aspect 6: The method of any of aspects 1 through 5, wherein receiving the indication of the secondary cell configuration for the first cell and the special cell configuration for the second cell comprises: receiving an indication of a plurality of secondary cell configurations for the first cell and a plurality of special cell configurations for the second cell, wherein the control message indicates the secondary cell configuration for the first cell from the plurality of secondary cell configurations and the special cell configuration for the second cell from the plurality of special cell configurations.

Aspect 7: The method of any of aspects 1 through 6, wherein the secondary cell configuration for the first cell and the special cell configuration for the second cell are received in a mobility configuration.

Aspect 8: The method of any of aspects 1 through 7, further comprising: receiving an indication of a measurement configuration for performing measurements on reference signals received from each deactivated cell of the set of cells.

Aspect 9: The method of any of aspects 1 through 8, further comprising: receiving an indication of a secondary cell index for the first cell, wherein the secondary cell index for the first cell is different from secondary cell indices for other cells in the set of cells configured for communications with the UE.

Aspect 10: The method of any of aspects 1 through 9, further comprising: receiving an indication of a range of secondary cell indices for the first cell, wherein the control message comprises an indication of a secondary cell index for the first cell at the second time, the secondary cell index selected from the range of secondary cell indices for the first cell.

Aspect 11: The method of any of aspects 1 through 10, wherein a special cell index for the second cell is zero at the second time, and a secondary cell index for the second cell is invalid at the second time.

Aspect 12: The method of any of aspects 1 through 11, further comprising: receiving a second control message configuring the second cell as a secondary cell at a third time, wherein a secondary cell index of the second cell at the third time comprises a secondary cell index of the second cell at the first time.

Aspect 13: The method of any of aspects 1 through 12, further comprising: receiving an indication of a secondary cell index for the second cell; and receiving a second control message configuring the second cell as a secondary cell at a third time, wherein a secondary cell index of the second cell at the third time comprises the indicated secondary cell index.

Aspect 14: The method of any of aspects 1 through 13, wherein the control message comprises a layer one or layer two control message.

Aspect 15: A method for wireless communication at a network entity, comprising: transmitting, to a UE, an indication of a configuration of a set of cells, the configuration comprising a secondary cell configuration for a first cell of the set of cells that is configured as a special cell at a first time and a special cell configuration for a second cell of the set of cells that is configured as a secondary cell at the first time; transmitting, to the UE, a control message configuring the first cell as a secondary cell at a second time and configuring the second cell as a special cell at the second time; and communicating, after the second time, with the UE via the first cell in accordance with the secondary cell configuration for the first cell and with the UE via the second cell in accordance with the special cell configuration for the second cell.

Aspect 16: The method of aspect 15, further comprising: transmitting an indication of a first special cell configuration for the first cell and a first secondary cell configuration for the second cell; and communicating, after the first time, with the UE via the first cell in accordance with the first special cell configuration for the first cell and with the UE via the second cell in accordance with the first secondary cell configuration for the second cell.

Aspect 17: The method of aspect 16, further comprising: transmitting an indication of a second special cell configuration for the first cell and a second secondary cell configuration for the second cell; and communicating, after a third time, with the UE via the first cell in accordance with the second special cell configuration for the first cell and with the UE via the second cell in accordance with the second secondary cell configuration for the second cell.

Aspect 18: The method of any of aspects 16 through 17, further comprising: transmitting an indication of a second special cell configuration for the first cell and a second secondary cell configuration for the second cell; and communicating, after a third time, with the UE via the first cell in accordance with the first special cell configuration for the first cell and with the UE via the second cell in accordance with the first secondary cell configuration for the second cell.

Aspect 19: The method of any of aspects 16 through 18, further comprising: transmitting an indication of a second special cell configuration for the first cell and a second secondary cell configuration for the second cell; transmitting, in a second control message, an indication of whether the UE is to communicate, after a third time, with the first cell in accordance with the first special cell configuration for the first cell or the second special cell configuration for the first cell; transmitting, in the second control message, an indication of whether the UE is to communicate, after the third time, with the second cell in accordance with the first secondary cell configuration for the second cell or the second secondary cell configuration for the second cell; and communicating, after the third time, with the UE via the first cell and the second cell in accordance with the second control message.

Aspect 20: The method of any of aspects 15 through 19, wherein transmitting the indication of the secondary cell configuration for the first cell and the special cell configuration for the second cell comprises: transmitting an indication of a plurality of secondary cell configurations for the first cell and a plurality of special cell configurations for the second cell, wherein the control message indicates the secondary cell configuration for the first cell from the plurality of secondary cell configurations and the special cell configuration for the second cell from the plurality of special cell configurations.

Aspect 21: The method of any of aspects 15 through 20, wherein the secondary cell configuration for the first cell and the special cell configuration for the second cell are transmitted in a mobility configuration.

Aspect 22: The method of any of aspects 15 through 21, further comprising: transmitting an indication of a measurement configuration for the UE to perform measurements on reference signals received from each deactivated cell of the set of cells.

Aspect 23: The method of any of aspects 15 through 22, further comprising: transmitting an indication of a secondary cell index for the first cell, wherein the secondary cell index for the first cell is different from secondary cell indices for other cells in the set of cells configured for communications with the UE.

Aspect 24: The method of any of aspects 15 through 23, further comprising: transmitting an indication of a range of secondary cell indices for the first cell, wherein the control message comprises an indication of a secondary cell index for the first cell at the second time, the secondary cell index selected from the range of secondary cell indices for the first cell.

Aspect 25: The method of any of aspects 15 through 24, wherein a special cell index for the second cell is zero at the second time, and a secondary cell index for the second cell is invalid at the second time.

Aspect 26: The method of any of aspects 15 through 25, further comprising: transmitting a second control message configuring the second cell as a secondary cell at a third time, wherein a secondary cell index of the second cell at the third time comprises a secondary cell index of the second cell at the first time.

Aspect 27: The method of any of aspects 15 through 26, further comprising: transmitting an indication of a secondary cell index for the second cell; and transmitting a second control message configuring the second cell as a secondary cell at a third time, wherein a secondary cell index of the second cell at the third time comprises the indicated secondary cell index.

Aspect 28: The method of any of aspects 15 through 27, wherein the control message comprises a layer one or layer two control message.

Aspect 29: An apparatus for wireless communication at a UE, comprising a processor; memory coupled with the processor; and instructions stored in the memory and executable by the processor to cause the apparatus to perform a method of any of aspects 1 through 14.

Aspect 30: An apparatus for wireless communication at a UE, comprising at least one means for performing a method of any of aspects 1 through 14.

Aspect 31: A non-transitory computer-readable medium storing code for wireless communication at a UE, the code comprising instructions executable by a processor to perform a method of any of aspects 1 through 14.

Aspect 32: An apparatus for wireless communication at a network entity, comprising a processor; memory coupled with the processor; and instructions stored in the memory and executable by the processor to cause the apparatus to perform a method of any of aspects 15 through 28.

Aspect 33: An apparatus for wireless communication at a network entity, comprising at least one means for performing a method of any of aspects 15 through 28.

Aspect 34: A non-transitory computer-readable medium storing code for wireless communication at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive an indication of a configuration of a set of cells, the configuration comprising a secondary cell configuration for a first cell of the set of cells that is configured as a special cell at a first time and a special cell configuration for a second cell of the set of cells that is configured as a secondary cell at the first time;
receive a control message configuring the first cell as a secondary cell at a second time and configuring the second cell as a special cell at the second time; and
communicate, after the second time, with the first cell in accordance with the secondary cell configuration for the first cell and with the second cell in accordance with the special cell configuration for the second cell.

2. The apparatus of claim 1, wherein the instructions are further executable by the processor to cause the apparatus to:
receive an indication of a first special cell configuration for the first cell and a first secondary cell configuration for the second cell; and
communicate, after the first time, with the first cell in accordance with the first special cell configuration for the first cell and with the second cell in accordance with the first secondary cell configuration for the second cell.

3. The apparatus of claim 2, wherein the instructions are further executable by the processor to cause the apparatus to:
receive an indication of a second special cell configuration for the first cell and a second secondary cell configuration for the second cell; and
communicate, after a third time, with the first cell in accordance with the second special cell configuration for the first cell and with the second cell in accordance with the second secondary cell configuration for the second cell.

4. The apparatus of claim 2, wherein the instructions are further executable by the processor to cause the apparatus to:
receive an indication of a second special cell configuration for the first cell and a second secondary cell configuration for the second cell; and
communicate, after a third time, with the first cell in accordance with the first special cell configuration for the first cell and with the second cell in accordance with the first secondary cell configuration for the second cell.

5. The apparatus of claim 2, wherein the instructions are further executable by the processor to cause the apparatus to:
receive an indication of a second special cell configuration for the first cell and a second secondary cell configuration for the second cell;
receive, in a second control message, an indication of whether to communicate, after a third time, with the first cell in accordance with the first special cell configuration for the first cell or the second special cell configuration for the first cell;
receive, in the second control message, an indication of whether to communicate, after the third time, with the second cell in accordance with the first secondary cell configuration for the second cell or the second secondary cell configuration for the second cell; and
communicate, after the third time, with the first cell and the second cell in accordance with the second control message.

6. The apparatus of claim 1, wherein the instructions to receive the indication of the secondary cell configuration for the first cell and the special cell configuration for the second cell are executable by the processor to cause the apparatus to:
receive an indication of a plurality of secondary cell configurations for the first cell and a plurality of special cell configurations for the second cell, wherein the control message indicates the secondary cell configuration for the first cell from the plurality of secondary cell configurations and the special cell configuration for the second cell from the plurality of special cell configurations.

7. The apparatus of claim 1, wherein the secondary cell configuration for the first cell and the special cell configuration for the second cell are received in a mobility configuration.

8. The apparatus of claim 1, wherein the instructions are further executable by the processor to cause the apparatus to:
receive an indication of a measurement configuration for performing measurements on reference signals received from each deactivated cell of the set of cells.

9. The apparatus of claim 1, wherein the instructions are further executable by the processor to cause the apparatus to:
receive an indication of a secondary cell index for the first cell, wherein the secondary cell index for the first cell is different from secondary cell indices for other cells in the set of cells configured for communications with the UE.

10. The apparatus of claim 1, wherein the instructions are further executable by the processor to cause the apparatus to:
receive an indication of a range of secondary cell indices for the first cell, wherein the control message comprises an indication of a secondary cell index for the first cell at the second time, the secondary cell index selected from the range of secondary cell indices for the first cell.

11. The apparatus of claim 1, wherein a special cell index for the second cell is zero at the second time, and a secondary cell index for the second cell is invalid at the second time.

12. The apparatus of claim 1, wherein the instructions are further executable by the processor to cause the apparatus to:
receive a second control message configuring the second cell as a secondary cell at a third time, wherein a secondary cell index of the second cell at the third time comprises a secondary cell index of the second cell at the first time.

13. The apparatus of claim 1, wherein the instructions are further executable by the processor to cause the apparatus to:
receive an indication of a secondary cell index for the second cell; and
receive a second control message configuring the second cell as a secondary cell at a third time, wherein a secondary cell index of the second cell at the third time comprises the indicated secondary cell index.

14. The apparatus of claim 1, wherein the control message comprises a layer one or layer two control message.

15. An apparatus for wireless communication at a network entity, comprising:
a processor;
memory coupled with the processor; and
instructions stored in the memory and executable by the processor to cause the apparatus to:
transmit, to a user equipment (UE), an indication of a configuration of a set of cells, the configuration comprising a secondary cell configuration for a first cell of the set of cells that is configured as a special cell at a first time and a special cell configuration for a second cell of the set of cells that is configured as a secondary cell at the first time;
transmit, to the UE, a control message configuring the first cell as a secondary cell at a second time and configuring the second cell as a special cell at the second time; and
communicate, after the second time, with the UE via the first cell in accordance with the secondary cell configuration for the first cell and with the UE via the second cell in accordance with the special cell configuration for the second cell.

16. The apparatus of claim 15, wherein the instructions are further executable by the processor to cause the apparatus to:
transmit an indication of a first special cell configuration for the first cell and a first secondary cell configuration for the second cell; and
communicate, after the first time, with the UE via the first cell in accordance with the first special cell configuration for the first cell and with the UE via the second cell in accordance with the first secondary cell configuration for the second cell.

17. The apparatus of claim 16, wherein the instructions are further executable by the processor to cause the apparatus to:
transmit an indication of a second special cell configuration for the first cell and a second secondary cell configuration for the second cell; and
communicate, after a third time, with the UE via the first cell in accordance with the second special cell configuration for the first cell and with the UE via the second cell in accordance with the second secondary cell configuration for the second cell.

18. The apparatus of claim 16, wherein the instructions are further executable by the processor to cause the apparatus to:
transmit an indication of a second special cell configuration for the first cell and a second secondary cell configuration for the second cell; and
communicate, after a third time, with the UE via the first cell in accordance with the first special cell configuration for the first cell and with the UE via the second cell in accordance with the first secondary cell configuration for the second cell.

19. The apparatus of claim 16, wherein the instructions are further executable by the processor to cause the apparatus to:
transmit an indication of a second special cell configuration for the first cell and a second secondary cell configuration for the second cell;
transmit, in a second control message, an indication of whether the UE is to communicate, after a third time, with the first cell in accordance with the first special cell configuration for the first cell or the second special cell configuration for the first cell;
transmit, in the second control message, an indication of whether the UE is to communicate, after the third time, with the second cell in accordance with the first secondary cell configuration for the second cell or the second secondary cell configuration for the second cell; and
communicate, after the third time, with the UE via the first cell and the second cell in accordance with the second control message.

20. The apparatus of claim 15, wherein the instructions to transmit the indication of the secondary cell configuration for the first cell and the special cell configuration for the second cell are executable by the processor to cause the apparatus to:
transmit an indication of a plurality of secondary cell configurations for the first cell and a plurality of special cell configurations for the second cell, wherein the control message indicates the secondary cell configuration for the first cell from the plurality of secondary cell configurations and the special cell configuration for the second cell from the plurality of special cell configurations.

21. The apparatus of claim 15, wherein the secondary cell configuration for the first cell and the special cell configuration for the second cell are transmitted in a mobility configuration.

22. The apparatus of claim 15, wherein the instructions are further executable by the processor to cause the apparatus to:
transmit an indication of a measurement configuration for the UE to perform measurements on reference signals received from each deactivated cell of the set of cells.

23. The apparatus of claim 15, wherein the instructions are further executable by the processor to cause the apparatus to:
transmit an indication of a secondary cell index for the first cell, wherein the secondary cell index for the first cell is different from secondary cell indices for other cells in the set of cells configured for communications with the UE.

24. The apparatus of claim 15, wherein the instructions are further executable by the processor to cause the apparatus to:
transmit an indication of a range of secondary cell indices for the first cell, wherein the control message comprises an indication of a secondary cell index for the first cell at the second time, the secondary cell index selected from the range of secondary cell indices for the first cell.

25. The apparatus of claim 15, wherein a special cell index for the second cell is zero at the second time, and a secondary cell index for the second cell is invalid at the second time.

26. The apparatus of claim 15, wherein the instructions are further executable by the processor to cause the apparatus to:
transmit a second control message configuring the second cell as a secondary cell at a third time, wherein a secondary cell index of the second cell at the third time comprises a secondary cell index of the second cell at the first time.

27. The apparatus of claim 15, wherein the instructions are further executable by the processor to cause the apparatus to:
transmit an indication of a secondary cell index for the second cell; and
transmit a second control message configuring the second cell as a secondary cell at a third time, wherein a secondary cell index of the second cell at the third time comprises the indicated secondary cell index.

28. The apparatus of claim 15, wherein the control message comprises a layer one or layer two control message.

29. A method for wireless communication at a user equipment (UE), comprising:
receiving an indication of a configuration of a set of cells, the configuration comprising a secondary cell configuration for a first cell of the set of cells that is configured as a special cell at a first time and a special cell configuration for a second cell of the set of cells that is configured as a secondary cell at the first time;
receiving a control message configuring the first cell as a secondary cell at a second time and configuring the second cell as a special cell at the second time; and
communicating, after the second time, with the first cell in accordance with the secondary cell configuration for the first cell and with the second cell in accordance with the special cell configuration for the second cell.

30. A method for wireless communication at a network entity, comprising:
transmitting, to a user equipment (UE), an indication of a configuration of a set of cells, the configuration comprising a secondary cell configuration for a first cell of the set of cells that is configured as a special cell at a first time and a special cell configuration for a second cell of the set of cells that is configured as a secondary cell at the first time;
transmitting, to the UE, a control message configuring the first cell as a secondary cell at a second time and configuring the second cell as a special cell at the second time; and
communicating, after the second time, with the UE via the first cell in accordance with the secondary cell configuration for the first cell and with the UE via the second cell in accordance with the special cell configuration for the second cell.
